(19) United States
(12) Patent Application Publication
(10) Pub. No.: US 2013/0018714 A1
(43) Pub. Date: Jan. 17, 2013

(54) INCENTIVE THROUGH RELAYING A GEO-SPATIALLY AWARE ADVERTISEMENT TO PROXIMATE PEERS

(71) Applicant: VARUGHESE GEORGE, Union City, CA (US)

(72) Inventor: VARUGHESE GEORGE, Union City, CA (US)

(21) Appl. No.: 13/182,464

(22) Filed: Jul. 14, 2011

(51) Int. Cl. G06Q 30/00

(52) U.S. Cl. 705/14.16

(57) ABSTRACT

A method, an apparatus and/or a system of incentive through relaying a geo-spatially aware advertisement to proximate peers is disclosed. In one aspect a method includes receiving through a multimedia device a media data from an advertisement server that is customized based on a set of characteristics associated with a present location of the multimedia device that nearly simultaneously communicates an information presented on the multimedia device through a transmission module of the multimedia device to a plurality of external observers via a wireless display device communicatively coupled to the multimedia device. The wireless display device is separate from the multimedia device. The method also includes providing a consideration proportional to a value of targeting in a particular geospatial area to an owner of the multimedia device through a payment module of the advertisement server.

### FIELD OF TECHNOLOGY

This disclosure generally relates to incentive through relaying a geo-spatially aware advertisement to proximate peers.

### BACKGROUND

Businesses may invest large sums of money on advertisements. The businesses may want their advertisements to reach as many people as possible within a given geospatial location to get a maximum return on their investments. A geo-spatial location may have numerous businesses. Each business in the geo-spatial location may have a number of advertisements for the different products and services. However, the geo-spatial location may have limited placement areas for projecting all the advertisements associated with the numerous businesses and the numerous products associated with each business. Businesses may distribute the advertisements through static mediums (e.g., such as print based advertisements, people holding up signs, billboards etc.) to reach an audience in the geo-spatial location. However, a flexibility of the business to change the advertisements dynamically based on a change in the audience that pass through the geo-spatial location may be limited through using static mediums. The businesses may not be able to permeate the advertisement to as many people as possible because of the rigid advertising structure of static mediums and limited placement locations within the geo-spatial location.

### SUMMARY

Disclosed are a method, an apparatus and/or a system of incentive through relaying a geo-spatially aware advertisement to proximate peers.

In one aspect a method includes receiving through a multimedia device a media data from an advertisement server that is customized based on a set of characteristics associated with a present location of the multimedia device that nearly simultaneously communicates an information presented on the multimedia device through a transmission module of the multimedia device to a plurality of external observers via a wireless display device communicatively coupled to the multimedia device. The wireless display device is separate from the multimedia device. The method also includes providing a consideration proportional to a value of targeting in a particular geospatial area to an owner of the multimedia device through a payment module of the advertisement server based a number of impressions of the media data rendered on the wireless display device to the plurality of external observers through the multimedia device of the owner and/or a consumer interaction between of the plurality of external observers and/or one of an entity associated with the media data and a representative of the entity based on a desired behavior marketed by the entity through the media data communicated via the multimedia device of the owner.

The method also includes automatically transmitting through a token module of the multimedia device a transaction information associated with the media data while the multimedia device communicates the media data to the plurality of external observers via the wireless display device. The transaction information may be retrievable by the plurality of external observers. The transaction information may be unique to each multimedia device and each media data communicated through the multimedia device. The method further includes publishing nearly simultaneously through a promotion module of the multimedia device the media data and/or the transaction information associated with the media data on a plurality of a social networking service platform and/or a blogging platform to communicate the media data to another plurality of external observers. The method also includes determining through a positioning module of the multimedia device the present location of the multimedia device, a previous location of the multimedia device and/or the set of characteristics associated with the present location of the multimedia device based on a set of location meta data extracted from a third party location tagging in a social network service platform in a public wide area network, a location tagging associated with the owner of the multimedia device and/or multimedia device and/or a navigation system. The method further includes transmitting an information associated with the present location, the set of previous location and/or the set of characteristics associated with the present location to the advertisement server through the multimedia device. The method also includes predicting a future location of the multimedia device through the mobility pattern module of the advertisement server based on a set of the present location information and/or a plurality of previous location information of the multimedia device. The set of characteristics associated with the present location the multimedia device and/or the future location may include the geo-spatial location information of the multimedia device, demographic diversity of the present location of the multimedia device, a spatial diversity of the location of the multimedia device, a time of the day, a season of the year and a diversity of a type of establishments in the present location of the multimedia device. The set of characteristics associated with the present location of the multimedia device and/or the wireless display device may include a user information associated with the plurality of external observers in the present location of the multimedia device and/or the wireless display device. If the external observers in the present location of the multimedia device and/or the wireless display device changes dynamically to a different set of external observers with respect to time, the multimedia device and/or the wireless display device may detect the change in the plurality of external observers and/or the multimedia device to calculate a new set of characteristics associated with the present location of the multimedia device and/or the wireless display device based on the change in the plurality of external observers.

The method also includes requesting the advertisement server through the multimedia device the media data and/or the transaction information associated with the media data based on the set of characteristics associated with the present location and/or the future location of the multimedia device. The method includes pre-caching the media data through a buffer module of the multimedia device to reduce a power consumption and network traffic of the multimedia device. The method also includes customizing through a selection module of the advertisement server the media data to be transmitted to the plurality of external observers via the multimedia device based on the set of characteristics associated with the present location of the multimedia device, a future location of the multimedia device and/or a preference of the owner of the multimedia device received through the multimedia device.

The method further includes automatically retrieving through the multimedia device a user identification information associated with the at least one of the plurality of external observers when the external observers are within a communicative range of the multimedia device, if at least one of the plurality of the external observers have a client instance of a service associated with multimedia device and/or the advertisement server present on a device associated with the plurality of external observers through which the at least one of the plurality of external observers intends to communicate with the multimedia device. The client instance is downloadable on registering to avail the service associated with multimedia device and/or the advertisement server. The method also includes receiving through the multimedia device a user identification information associated with at least one of the plurality of external observers based on a request of the multimedia device to obtain the user identification information when the external observers are within a communicative range of the multimedia device and the at least one of the plurality of the external observers is not registered to avail the service associated with the multimedia device and/or the advertisement server. The request of the multimedia device to obtain user identification information is sent to a communication device 650 associated with at least one of the plurality of external observers through which the at least one of the plurality of external observers intends to communicate with the multimedia device. The method includes transmitting the user identification information to the advertisement server. The method also includes matching through the selection module of the advertisement server a user identification information with a user profile stored in a profile database of the advertisement sever to generate a media data that may be customized based on at least one of a user behavioral pattern and an information associated with the user profile. The method also includes forming a group between the owner of the multimedia device, another owner of another multimedia device and/or at least one of the plurality of the external observers that have registered to avail the service associated with the multimedia device and/or the advertisement server. The method further includes communicating through the promotion module of the multimedia device the media data and/or the transaction information associated with the media data to the group formed between the owner of the multimedia device, another owner of another multimedia device and/or at least one of the plurality of the external observers.

The method also includes dynamically changing the media data that is displayed on the wireless display device when the wireless display device along with the multimedia device coupled to the mobile medium moves from one geo-spatial location to another geospatial location based on a motion of the mobile medium. The rate of change between different media data displayed on the wireless display device may be associated with the rate of the motion of the mobile medium and/or a present location and/or a future location of the multimedia device and/or the wireless display device coupled to the mobile medium. The media data is received from the advertisement server through the multimedia device based on a set of characteristics associated with the present location and/or a future location of the multimedia device that is transmitted to the advertisement server. The media data received from the advertisement server may be a media data associated with a future location of the multimedia device and/or the mobile medium to which the multimedia device is coupled. The media data may be buffered in the multimedia device which is displayed when at least one of the multimedia device and the wireless display device is in proximity of an appropriate location associated with the media data. The appropriate location may be within the future location. The promotion module may determine at least one of a temporal rate of change of different media data and a frame rate of each media data displayed on the wireless display device based on a form factor of the wireless display device and/or a display safety regulation. The wireless display device may display a static display content, a dynamic display content and/or an interactive display content associated with the media data. If the wireless display device is coupled to mobile medium, the wireless display device may adjust a speed of the display based on a rate of motion of the mobile medium and/or display content. The advertisement server may provide the transaction information associated with the media data to the multimedia device.

In another aspect, a system includes an advertisement server. The system also includes a multimedia device configured to receive a media data from the advertisement server that is customized based on a set of characteristics associated with the present location of the multimedia device and/or the wireless display device communicatively coupled to the multimedia device. The multimedia device to nearly simultaneously communicate information presented on the multimedia device to a plurality of external observers. The system further includes a payment module of the advertisement server configured to provide a consideration proportional to a value of targeting in a particular geospatial area to an owner of the multimedia device based on a number of impressions of the media data rendered on the wireless display device to the plurality of external observers through the multimedia device of the owner and/or an interaction between at least one of the plurality of external observers and an entity associated with the media data based on a desired behavior marketed by the entity through the media data communicated via the multimedia device of the owner.

In yet another aspect, a method includes receiving through a multimedia device a media data from an advertisement server that is customized based on a set of characteristics associated with a present location of the multimedia device that nearly simultaneously communicates an information presented on the multimedia device through a transmission module of the multimedia device to a plurality of external observers via a wireless display device communicatively coupled to the multimedia device. The wireless multimedia device is separate from the multimedia device. The method also includes providing a consideration proportional to a value of targeting in a particular geospatial area to an owner of the multimedia device through a payment module of the advertisement server based on a number of impressions of the media data rendered on the wireless display device to the plurality of external observers through the multimedia device of the owner and/or an interaction between at least one of the plurality of external observers and an entity associated with the media data based on a desired behavior marketed by the entity through the media data communicated via the multimedia device of the owner. The method further includes publishing nearly simultaneously through a promotion module of the multimedia device at least one of the media data and the transaction information associated with the media data on a plurality of a social networking service platform and a blogging platform to communicate the media data to another plurality of external observers.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an advertisement server, a multimedia device and a wireless display device communicating media data to external observers, according to one or more embodiments.

FIG. 2 is a process flow view of FIG. 1 illustrating the advertisement server, the multimedia device and the wireless display device communicating media data to external observers, according to one or more embodiments.

FIG. 3 is an exploded view illustrating the multimedia device of FIG. 1, according to one or more embodiments.

FIG. 4 is an exploded view illustrating the advertisement server of FIG. 1, according to one or more embodiments.

FIG. 5 is a process flow view of FIG. 1 illustrating the advertisement server, the multimedia device and the wireless display device communicating media data to external observers in an active mode of operation, according to one or more embodiments.

FIG. 6 is a system view of an advertisement server, a multimedia device and a wireless display device communicating media data to external observers including publishing, according to one or more embodiments.

FIG. 7 is an example embodiment of a user interface of the multimedia device of FIG. 1, according to one or more embodiments.

FIG. 8A is an example embodiment of communicating media data to external observers through the multimedia device when the multimedia device moves across multiple geospatial locations, according to one or more embodiments.

FIG. 8B is an example embodiment of communicating media data to external observers through the multimedia device when the multimedia device in an example geospatial location, according to one or more embodiments.

FIG. 9 is a diagrammatic representation of a data processing system capable of performing a set of instructions to perform any one of the methodologies herein, according to one or more embodiments.

FIG. 10 is an example embodiment of an advertisement server 106 based user interface, according to one or more embodiments.

FIG. 11 is a system view of an extension of FIG. 1 illustrating a method of forwarding the media data and/or the transaction information between external observers, according to one or more embodiments.

FIG. 12 is a flow chart illustrating a method of the multimedia device to communicate a media data to external observers and to provide a consideration to an owner of the multimedia device therein, according to one or more embodiments.

FIG. 13 is a flow chart illustrating a method of the multimedia device to communicate a media data to external observers through publishing and/or display through a wireless display device and to provide a consideration to an owner of the multimedia device therein, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or system of incentive through relaying a geo-spatially aware advertisement to proximate peers. Although the present embodiments have been described with reference to specific example embodiments, it will be evident that various modifications and changes may be made to these embodiments without departing from the broader spirit and scope of the various embodiments.

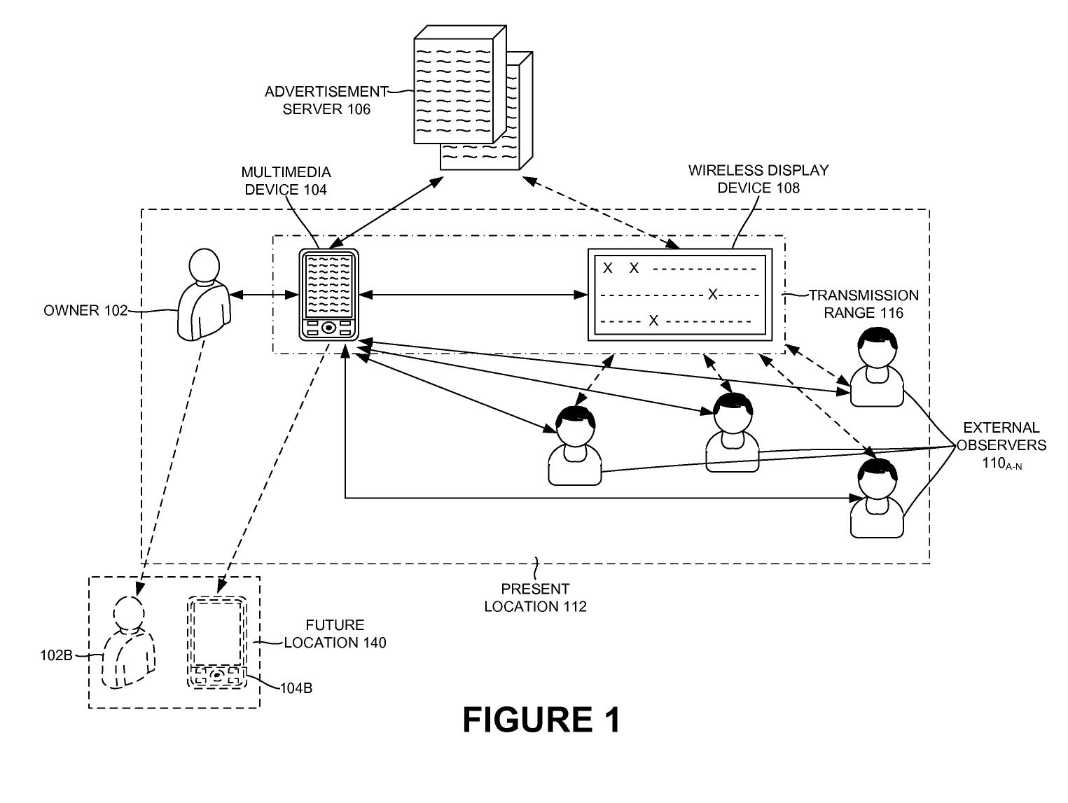

FIG. 1 is a system view of an advertisement server, a multimedia device and a wireless display device communicating media data to external observers, according to one or more embodiments. In particular the embodiment of FIG. 1 illustrates an advertisement server 106, a multimedia device 104, a wireless display device 108, an owner of the multimedia device 102, a transmission range of the 116, a present location 112, a future location 140 and a number of external observers 110a-n.

In one or more embodiments, the advertisement server 106 may be a cloud based server, a virtual sever and/or a physical sever device. The advertisement server 106 may be at a remote location from the multimedia device 104. The remote location may be remote from the present location 112. In some embodiments the advertisement server may be communicatively coupled to the multimedia device 104. The advertisement server 106 may communicate with the multimedia device 104 via a wired network and/or a wireless network. In one embodiment, the advertisement server may be at the present location 112.

In one or more embodiments, the advertisement server may receive a set of characteristics associated with a present location 112 of the multimedia device 104. In some embodiments, the advertisement server may be configured to receive a set of previous locations of a multimedia device 104. In one embodiment, the set of characteristics associated with a present location 112 of the multimedia device 104 may be gathered through the multimedia device 104. In one embodiment, the multimedia device 104 may actively scan the present location to gather the set of characteristics associated with present location 112 of the multimedia device 104. In another embodiment, the multimedia device 104 may passively receive the set of characteristics associated with the present location 112 of the multimedia device 104 from the source of the set of characteristics.

In one embodiment, the multimedia device 104 may actively gather information of the set of previous locations and/or present location through requesting for the same from information towers (e.g., cell towers) and/or a set of location meta data extracted from a third party location tagging in a social network service platform in a public wide area network (e.g., check-in using Facebook places, Foursquare, Twitter etc.). In one embodiment, the multimedia device 104 may passively gather information of previous locations when such information is transmitted to the multimedia device 104 by appropriate sources. In one embodiment, the multimedia device may have an inbuilt feature to determine the location of the multimedia device 104 and the locations of the multimedia device 104 may be stored in a memory associated with the multimedia device 104 which may be used when needed. In another embodiment, the location information may be streamed live to the advertisement server that may store the location information on the fly in a database of the advertisement server 106.

In one embodiment, the multimedia device 104 may be automatically transmitting its location coordinates to the advertisement server 106. In one embodiment, based on the location coordinates of the multimedia device 104, the advertisement server 106 may customize a media data based on the location information. The media data that is customized based on the location information from the multimedia device 104 may be transmitted to the multimedia device to be communicated to the number of external observers (e.g., plurality of external observers) through the wireless display device 108. In one embodiment, the multimedia device 104 may scan the present location of the multimedia device 104 to obtain information of the external observers in the present location. The multimedia device 104 may transmit this information to the advertisement server. The advertisement server 106 may augment this information with inter alia a demographic, a seasonal, a temporal, an age group information etc. of the present location to customize the media data to be displayed in the present location of the multimedia device 104 and/or the wireless display device 108. The advertisement server 106 may receive the demographic, the seasonal, the temporal, the age group information etc. of the present location through third party sources such a network service providers, social networking platforms and/or blogging platforms.

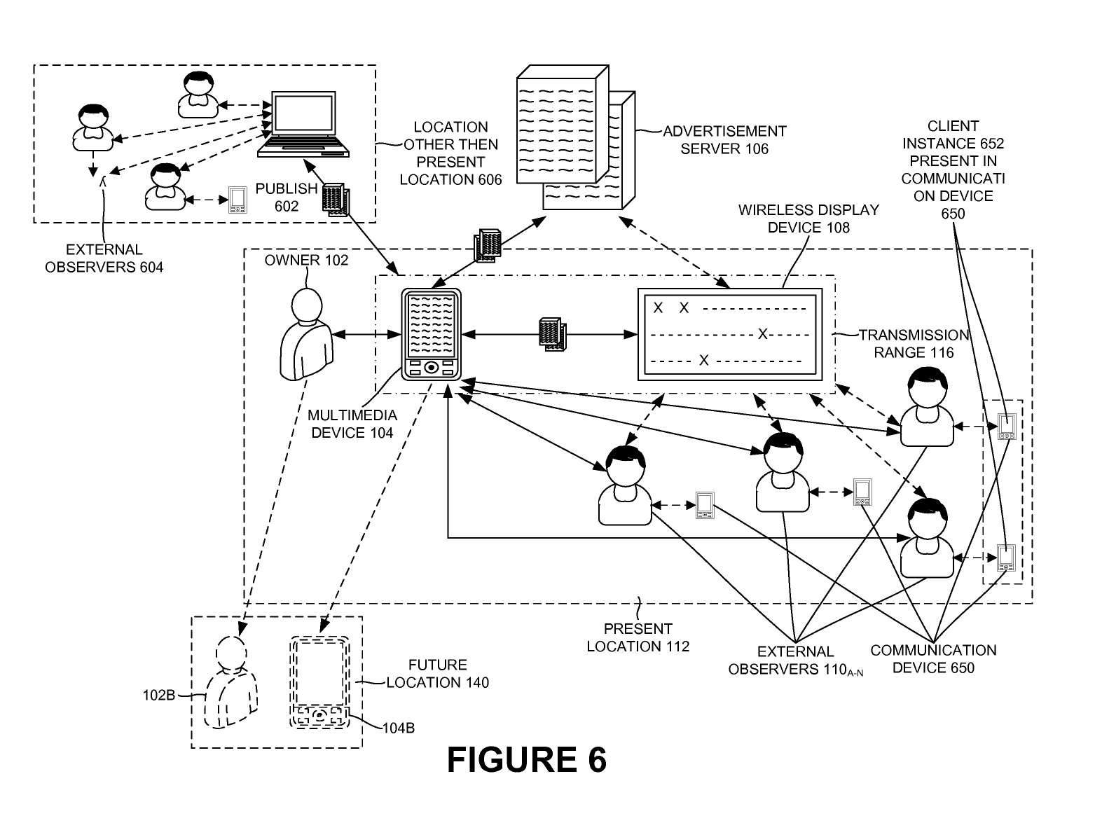

In one embodiment, the advertisement server 106 may receive and information associated with the number of external observers in the present location of the multimedia device 104 through a third party source such as a network service provider. In one embodiment, the advertisement server 106 may have the location of the multimedia device 104 since the multimedia device 104 may transmit location information of the multimedia device 104 to the advertisement server 106. In an example embodiment, if the multimedia device is in location XYZ, the multimedia device may send its location XYZ to the advertisement server. The advertisement server may communicate with a network service provider and find the information of all the external observers at location XYZ in the proximity of the multimedia device. The advertisement server may choose a specific advertisement for the multimedia device to display to external observers through the wireless display device. The advertisement may be chosen based on the information the advertisement server received through the network service provider. In this example embodiment, the multimedia device 104 may only transmit its own location to the advertisement server 106. In one embodiment, the multimedia device 104 may transmit its location as well as the information of the external observers in the present location of the multimedia device through scanning for that information. In one embodiment, the scanning may include sending a request message for the information. The multimedia device may broadcast the request information in the present location. A communication device 650 (shown in FIG. 6) associated with the external observer may respond to the request with the information required. The request and receive operation may happen agnostic to the external observer and the owner of the multimedia device, according to one embodiment. In another embodiment, the location of the multimedia device 104 may be continuously tracked by the advertisement server 106. In this embodiment, the multimedia device may not have to send its location information but rather, the advertisement server 106 may remotely track the location. In one embodiment, when the communication device 650 associated with the external observer has a client software (e.g., client instance 652 of a service associated with the advertisement server 106 and/or the multimedia device 104) installed on the communication device 650, the communication device 650 may transmit information associated with the external observer to the advertisement server 106 based on a configuration of the client software. In one embodiment, the communication device 650 associated with external observer 110 may transmit the present location of the communication device 650 to the advertisement server 106 based on a configuration of the client instance 652 present on the communication device 650. In one embodiment, the advertisement server 106 may receive a set of characteristics associated with the present location of the multimedia device 104 from the external observer through a communication device 650 of the external observer when the communication device is within the present location of the multimedia device, from the multimedia device 104 itself and/or from third party sources such as network service providers, social networking platforms etc.

In one embodiment, the active operations mentioned above may be performed by the owner of the multimedia device 102 through a user interface of the multimedia device 104. In one embodiment, the multimedia device may have a specific user interface for the owner 102 of the multimedia device 104 to interact through and/or with the multimedia device 104. In one embodiment, the active operations mentioned above may be automatically performed by the multimedia device 104.

The advertisement server 106 may be configured to combine inter alia the information of the present location, the set of previous locations, speed of motion and/or direction of motion of a multimedia device and/or wireless display device when the multimedia device and/or the wireless display device is coupled to a mobile medium to predict a future location 140 of the multimedia device 104. In certain embodiments, the advertisement server 106 may be configured to receive information of the external observers in the present location 112 of the multimedia device 104. In one embodiment, the advertisement server 106 may be configured to receive information of the external observers in a present location of the wireless display device 108. In one embodiment, the advertisement server 106 may receive information regarding the external observers from the multimedia device 104 that scans through the present location to gather the information. In one embodiment, scanning may include pinging associated with a request response mechanism between the external observer's communication device 650 and the multimedia device to exchange information.

The advertisement server 106 may be configured to generate a media data to be communicated to the set of external observers 110a-n through the multimedia device which then communicates the media data through the wireless display device 108. The advertisement server 106 customizes the media data based on a set of characteristics associated with the present location 112, the future location 140 of a multimedia device 104, the information of the external observers 110a-n in the present location of the multimedia device 104 and/or the wireless display device 108. In one or more embodiments, the media data may be inter alia an advertisement, a promotional video and/or an infomercial, a commercial video and/or awareness video. In one embodiment, the media data may be an image and/or a document associated with an advertisement. In one embodiment, the media data may be associated with a poster advertisement. In one embodiment, the media data may include dynamic display content. In another embodiment, the media data may include static display content. The static display content may be an image, a poster content and/or an interactive content document. In one embodiment, a meta data of a media data may be sent from the advertisement server 106 to the multimedia device 104. The multimedia device 104 may reconstruct the media data from the meta data of the media data. In one embodiment, the advertisement server 106 may send the media data as a whole. In one embodiment, a meta data of a media data may be sent from the multimedia device 104 to the wireless display device 108. The wireless display device 108 may reconstruct the media data from the meta data of the media data. The metadata of the media data may be transmitted to reduce a network congestion and/or maximize the utility of a network bandwidth. For example, the dynamic display content may be a video content, an audio content and/or an audio-visual content associated with an advertisement. In one embodiment, when the media data that is played through the wireless display device is an audio and/or audio visual data, the volume of the audio may be controlled manually and/or automatically to match the present location of the multimedia device and/or the wireless display device. In one embodiment, the wireless display device may have a capability to play audio files. The advertisement server may be coupled to the multimedia device 104 and/or the wireless display device 108. In certain embodiments, the advertisement server 106 may also communicate directly with the wireless display device 108.

In one or more embodiments, the multimedia device 104 may be a two way communication device (e.g., smart phone, iPad, iPod, tablet, laptop, desktop computer, utility computing devices, etc.) In one embodiment, the multimedia device 104 may have specialized software. In one embodiment, a multimedia device 104 may serve a plurality of wireless display devices. The multimedia device 104 may be coupled to the advertisement server 106, the number of external observers 110a-n, the wireless display device 108 and/or the owner 102. In one or more embodiments, the multimedia device 104 may receive information (e.g., a media data (not shown in FIG. 1)) from the advertisement server 106. The multimedia device 104 may nearly simultaneously communicate the information received from the advertisement server 106 to the number of external observers 110a-n, through the wireless display device 108. In some embodiments, the multimedia device 104 may receive information (user information) from at least one of the number of external observers 110a-n. In certain embodiments, the multimedia device 104 may communicate relevant information (e.g., location information of the multimedia device 104 and/or wireless display device 108, user information received from the number of external observers) to the advertisement server 106. The multimedia device may have a display module (not shown in FIG. 1) through which the owner may interact with the multimedia device 104 to communicate with the advertisement server 106, the external observers 110a-n and/or the wireless display device 108. In one or more embodiments, the multimedia device 104 may communicate with the advertisement server 106, the number of external observers 110a-n and/or the wireless display device 108 through a wireless network. The wireless network may be a Wi-Fi™, WiMAX®, Wibree™, ZigBee® 3G/4G and/or Bluetooth network. In one embodiment, any networking protocol may be used. The wireless protocol used to communicate may be automatically selected based on the desired transmission range, efficiency, congestion etc. In some embodiments, the multimedia device 104 may communicate with the advertisement server through a LAN and/or wired network. In certain embodiments, the multimedia device may communicate with the wireless display device through a wired network and/or USB, provided that the wireless display device has the corresponding interface. In another embodiment, the multimedia device 104 may communicate the information presented on the multimedia device 104 from the advertisement server 106 to the number of external observers 110a-n through a display device which is external to the multimedia device 104. The display device may have a wireless and/or wired interface. In one embodiment, the multimedia device 104 may be communicatively coupled to the wireless display device 108. In one embodiment, the wireless display device may be outside the present location 112 of the multimedia device 104. When the wireless display device is outside the present location 112 of the multimedia device 104 or when the wireless display device 108 is outside the transmission range 116 of the multimedia device 104, then the multimedia device 104 may communicate with wireless display device 108 in an ad-hoc manner through pre-existing well established communication paths (cell towers, satellite, etc.).

In one or more embodiments, the wireless display device 108 may be a television, an LCD screen, LED screen, wearable displays, tablets and/or a paper thin display devices. In one embodiment, the wireless display device 108 may be a commercially viable display device. The wireless display device may display multidimensional content. In one embodiment, the wireless display device may display 2D content. In another embodiment, the wireless display device may display 3D content. In one embodiment, the wireless display device 108 may be configured to play audio files as well. In one embodiment, the wireless display device 108 may be separate from the multimedia device 104. The wireless display device 108 may be a portable device. The wireless display device 108 may be communicatively coupled to the multimedia device 104 and/or the advertisement server through a wireless network and/or a wired network based on an interface available on the wireless display device. For example, in some embodiments, if the wireless display device 108 has a USB port, then the multimedia device 104 may be communicatively coupled to the wireless display device 108 through a USB cable. The wireless display device 108 may be coupled to a stationary and/or mobile medium. In one embodiment, the wireless display device may be coupled to a building structure, a wall, a table, a door and/or a window panel. In one embodiment, the wireless display device may be coupled to any surface that a commercially viable display device can be placed. For example, the wireless display device 108 may be attached to a window panel of a coffee shop. In another example embodiment, the wireless display device 108 may be at attached to a public and/or private transportation vehicle which is mobile across multiple geospatial location (e.g., moving car, moving van, flying electronic banner, blimps, etc).

The wireless display device 108 may be configured to project (e.g., display and/or play) information presented on the multimedia device 104 to a number of external observers 110a-n. In some embodiments, the wireless display device 108 may be I/O device. In certain embodiments, the wireless display device 108 may be configured to communicate a set of characteristics associated with the present location 112 of the wireless display device 108, when the number of external observers 110a-n are not in a transmission range 116 of the multimedia device 104. The wireless display device 108 may communicate the set of characteristics associated with the present location 112 to an advertisement server 106 and/or the multimedia device 104. The wireless display device 108 may communicate with the multimedia device 104 through a wireless ad-hoc network, when the wireless display device 108 is not in the transmission range 116 of the multimedia device 104.

Each of the number of external observers 110a-n may have a communication device 650 (e.g., smart phones, PDAs, iPads, iPod Touch etc.). At least one of the number of the external observers 110a-n may have a client side application (e.g., client instance 652) (shown in FIG. 6) associated with a service provided by the advertisement server 106 and/or the multimedia device installed on their communication device. In some embodiments, the client side application may not be installed on the communication device; instead it may be installed on laptop, a home PC etc. In certain embodiments, the client side application may be pre-installed in vehicles. The external observers 110a-n may automatically access through the client side application, a transaction information transmitted by the multimedia device associated with media data being communicated to the external observers 110a-n through the wireless display device 108. The transaction information may be a token, a unique code, a bar code, a virtual coupon, etc. associated with the media data being communicated to the external observers 110a-n through the wireless display device 108. In some embodiments, when the external observers 110a-n installs the client side application on their communication devices, a user profile associated with each of the number of external observers 110a-n that installed the client side application may be stored in a database (e.g., information database) in the advertisement server 106.

In one embodiment, the advertisement server 106 may be a content server. In one embodiment the advertisement server 106 may be a configuration server. In one embodiment, the advertisement server 106 may be a streaming server. In one embodiment, the advertisement server 106 may be a rule server. In one embodiment, the advertisement server 106 may be a multimedia server. In one embodiment, the advertisement server 106 may be a combination of any of the above mentioned servers.

In one or more embodiments, advertisement sharing in a geospatial location may enable an owner 102 of the multimedia device 104 to use a geo spatial location accessible to the owner 102, for displaying media data associated the geo-spatial location using the wireless display device 108 to engage external observers 110a-n in a proximity of the multimedia device 104 and/or the wireless display device 108. The multimedia device 104 communicatively coupled to the wireless display device 108 may use the set of characteristics associated with the present location and/or future location of the multimedia device to communicate a media data based on the set of characteristics thereof to maximize an engagement of the external observers in the proximity and/or within the present location and/or the future location of the multimedia device 104.

In some embodiments, the media data communicated to the external observers 110a-n may be based on a set of characteristics associated with the present location of the wireless display device 108. The multimedia device 104 may obtain a present location of the multimedia device 104 and/or the wireless display device 108 based on GPS, A-GPS, network triangulation and/or information on social networking sites. In some embodiments, the location information may also be obtained when the owner 102 of the multimedia device 104 manually enters a location of the multimedia device 104 and/or the wireless display device 108.

The multimedia device 104 may detect the number of external observers 110a-n through scanning for communication devices associated with the external observers 110a-n (not shown in FIG. 1), information from network providers and/or online check-in information that the external observers 110a-n enters in social networking sites (e.g., Facebook places, Foursquare, etc.). In one embodiment, the client instance 652 may be configured to transmit a location of the external observer to the advertisement server 106. In some embodiments, if the communication device 650 associated with an external observer has the client device application installed on the communication device, then the multimedia device may detect the external observer through the client side application when the communication device 650 associated with the external user is in the proximity of the multimedia device 104. The client instance 652 associated with the service provided by the advertisement server 106 and/or the multimedia device 104 may automatically detect the proximity of the communication device 650 on which the client application (e.g., client instance 652) runs and transmit the location to the multimedia device 104. When the communication device 650 thereof is in a proximity of the multimedia device 104 the client device may alert the multimedia device 104 of its presence through a wireless signal. The multimedia device 104 may transmit the location and/or user information to the advertisement server 106. The client instance 652 may transmit unique identifier information to the multimedia device 104 and/or advertisement server 106 to recognize each of the external observers that are registered users of the service associated with the multimedia device 104 and/or the advertisement server 106. The advertisement server 106 may obtain a user behavior pattern based on a registration information of the user stored in the database of the advertisement server 106, if the user is an external observer that has the client side application installed on the communication device 650 of the external user.

The advertisement server 106 may customize the media data to be communicated the number of external observers 110a-n based on the set of characteristics associated with the present location and/or future location of the multimedia device 104, the set of characteristics associated with the present location and/or future location of the wireless display device 108, the user online behavior pattern, user offline behavior pattern and/or user information.

The multimedia device 104 may transmit a transaction information associated with the media data being communicated nearly simultaneously to the external observers 110a-n through the wireless display device 108. The external observers 110a-n may receive the transaction information through their communication device 650 via a gesture on the communication device. In some embodiments, if the communication devices of the external observers 110a-n have the client side application installed, then the client side application may automatically collect the transaction information. In certain embodiments, the external observers 110a-n may choose a transaction information associated with a specific media data based on a requirement of the external observer. The transaction information associated with the media data communicated by the multimedia device 104 through the wireless display device 108 may be unique to each multimedia device 104 and each media data. The transaction information may also be displayed in the form of a code in the wireless display device for external observers 110a-n that do not have a communication device 650 and/or a communication device 650 that is a smart phone. In one embodiment, the external observers may nearly simultaneously search for different transaction information which completing a purchase associated with a previously collected/received transaction information through a multitasking ability of the communication device 650 of the external observer. The external observers 110a-n may share the media data and/or the transaction information associated with the media data to another set of external observers and/or another user (e.g., friends). In some embodiments each of the external observers may share the media data and/or the transaction information associated with the media data through publishing the media data content and/or the transaction information associated with the media data in a social networking profile associated with each of the external observers 110a-n, text message and/or multimedia message.

The multimedia device 104 may pre-cache a set of media data to provision for network interruption and optimize the bandwidth usage of the network. The multimedia device 104 may limit the set of media data to a threshold amount to optimize the power consumption of the multimedia device 104. The pre-caching in itself may reduce the power consumption of the multimedia device 104 as compared to a live streaming of the media data. The set of media data may be pre-cached based on the set of characteristics associated with the present location of the multimedia device 104 and/or the future location of the multimedia device 104. The demographic information of a future location may be obtained through other devices in the proximity of the future location 140 of the multimedia device 104 and/or the network service providers in the future location 140 of the multimedia device 104 predicted through the advertisement server 106. In one embodiment, the media data may also be provided as live stream content between a communicative pair formed from a combination of the advertisement server 106, the multimedia device 104 and/or the wireless display device 108.

In some embodiments, the owner 102 of the multimedia device 104 may be provided a consideration (e.g., monetary) based on the number of impressions of the media data, communicated through the multimedia device 104 of the owner 102, rendered on the wireless display device 108 to the number of external observers 110a-n. In certain embodiments, the owner 102 of the multimedia device 104 may be provided a consideration based on an interaction between at least one of the number of external observers 110a-n and a commercial entity based on a desired behavior marketed by the commercial entity through the media data. For example, when the external observer collects the coupon associated with the customized advertisement and uses the coupon to buy a product promoted through the customized advertisement, the owner of the multimedia device 102 receives a fraction of the sale price or a fixed amount. In other embodiments, the consideration may be provided to the owner 102 of the multimedia device 104 based on the number of transaction information collected by the external observers, the number of collected transaction information shared with other external observers and/or a number of page visits based on the transaction information. If the multimedia device 104 and the wireless display device 108 are not associated with the same owner 102, then the advertisement server 106 may provide a consideration to both the owner of the multimedia device 104 and the owner of the wireless display device 108 separately based on the aforementioned conditions. In yet another embodiment, the advertisement server may also provide a consideration to the external observers based on a sharing of the transaction information by the external observers.

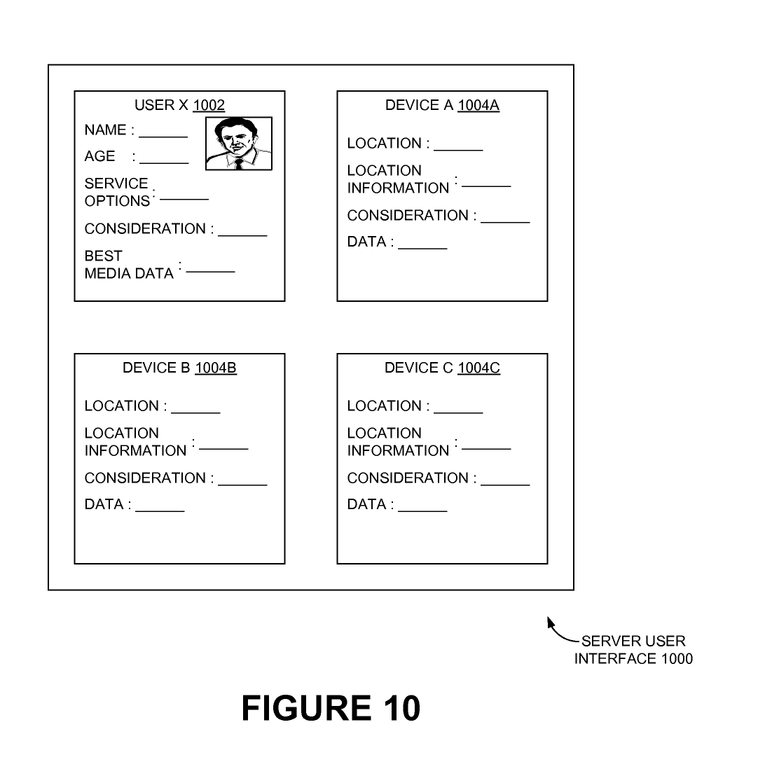

In one embodiment, the media data and/or the transaction information associated with the media data may be forwarded directly to the number of external observers (e.g., plurality of external observers 110a-n) through the multimedia device 104. The media data and/or the transaction information associated with the media data may be retrieved by the number of external observers through each of a communication device 650 (shown in FIG. 6) associated with each of the number of external observers. In one embodiment, the number of external observers may forward the media data and/or the transaction information associated with the media data forwarded through the multimedia device 104 to another set of number of external observers (shown in FIG. 10). The external observer may make a purchase associated with a media data and/or the transaction information associated with the media data. The external observer may make the purchase through physically visiting the store and making an in-store purchase. In one embodiment, the external observer may make an online purchase. The transaction information may be unique to the multimedia device and the media data. In one embodiment when the external observer makes a purchase, the owner 102 of the multimedia device may receive a consideration through the payment module of the advertisement server 106. In another embodiment, the consideration may be divided between the owner 102 and at least one of the number of external observers 110a-n when at least one of the external observer of the other set of number of external observers makes a purchase based on the media data and/or the transaction information associated with the media data that is forwarded from the at least one of the number of external observers 110a-n

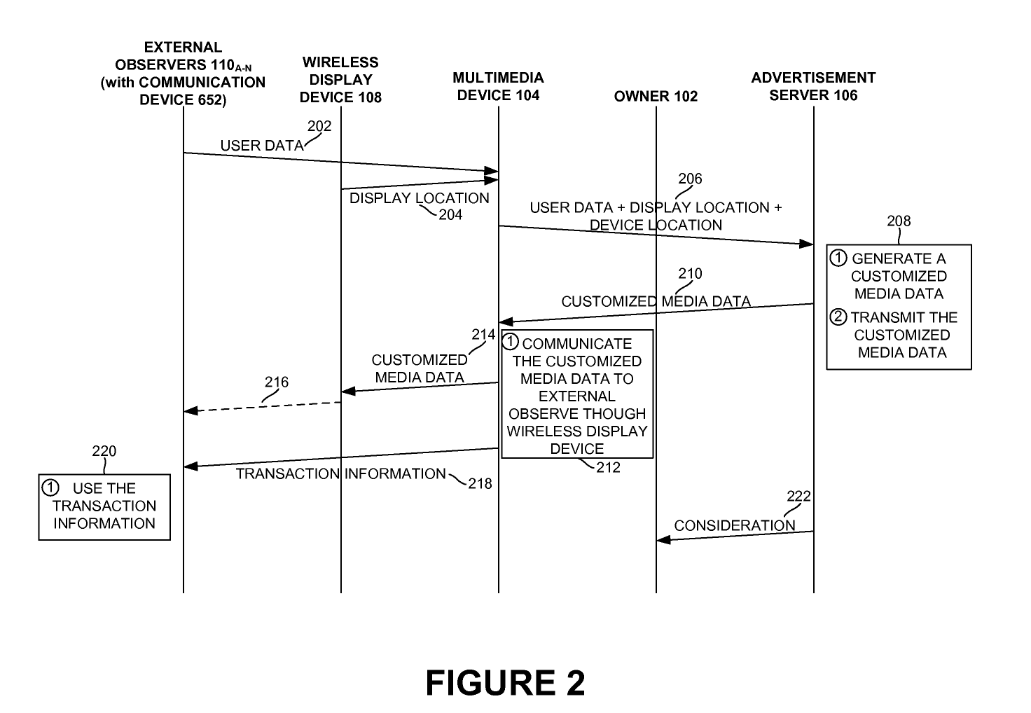

In the embodiment of FIG. 1, the owner 102 of the multimedia device 104 may be in a close proximity of the multimedia device 104. For example, the owner 102 may be carrying the multimedia device 104. The owner 102 of the multimedia device 104 may be in the present location 112 along with the multimedia device 104 (see the embodiment of FIG. 1). In some embodiments, the owner 102 of the multimedia device 104 may be away from the multimedia device 104 and/or outside the present location 112. For example, the owner 102 may be in a mall and the owner may have left the multimedia device 104 in his vehicle parked next to the mall. In some embodiments, the multimedia device 104 and the wireless display device 108 may both be associated with the owner 102. In certain embodiments, the multimedia device 104 may be associated with the owner 102, whereas the wireless display device 108 may be associated with another user. In another embodiment, the multimedia device 104 may be configured to be a software application. The multimedia device 104 may be a hardware unit and/or a software application. When the multimedia device is a software application, the software application thereof may be downloaded on another hardware device (e.g., smart phone) and the other hardware device may operate as the multimedia device 104. In certain embodiments, the multimedia device 104 as a software application may be pre-installed in vehicles. The interaction between the advertisement server 106, the multimedia device 104, the owner 102, the number of external observers 110a-n and/or wireless display device 108 may be illustrated in FIG. 2.

In one embodiment, the advertisement server 106 may store a plurality of media data in a database of the advertisement server 106. In one embodiment, the plurality of the media data may be associated with various entities. In one embodiment, the advertisement server 106 may not be associated or owned by the various entities. In one embodiment, the advertisement server may act as an intermediary between the owner 102 of the multimedia device 104, the plurality of external observers 110 and the entities that promote a desired behavior marketed by the media data through communicating the media data to the plurality of external observers 110 through the multimedia device 104 via the wireless display device 108. For example, a company XYZ may own and administer the advertisement server 106 which may store advertisements associated with companies like Coke, Burger King, Chevron etc., and the external observers and/or the owner 102 of the multimedia device 104 may register with company XYZ to obtain a service provided by company XYZ. In one embodiment, the advertisement may be received from advertisement agencies and/or syndication platforms (e.g., Google ad sense etc.) as well. The owner 102 may communicate a relevant advertisement from Coke through the owner's multimedia device 104 to the external observers 110 via the wireless display device 108. Company XYZ may get a consideration from Coke for promoting their advertisement and then Company XYZ may provide a fraction of the consideration to the owner 102 of the multimedia device 104 based on certain criterion. In the example embodiment Company XYZ is different from the companies like Coke, Burger King, Chevron etc. that come to Company XYZ to obtain a service of company XYZ to promote their advertisements through Company XYZ via the multimedia device 104 and/or the wireless display device 108. In the example embodiment, Company XYZ may also provide the multimedia device 104 to the owner 102. In another example embodiment, the wireless display device 108 may also be provided by the Company XYZ. It must be noted that this is merely an example embodiment and Company XYZ may use various other models to carry out the business. In one embodiment, the owner may be a franchise.

FIG. 2 is a process flow view of FIG. 1 illustrating the advertisement server, the multimedia device and the wireless display device communicating media data to external observers, according to one or more embodiments. In particular the embodiment of FIG. 2 illustrates an interaction between the advertisement server 106, the multimedia device 104, the owner 102, the number of external observers 110a-n and/or wireless display device 108.

In one or more embodiments, the multimedia device 104 may operate in a passive mode and/or an active mode. In one embodiment, the owner 102 of the multimedia device 104 may switch the multimedia device 104 from a passive mode to and active mode and vice versa. In one embodiment, the multimedia device 104 may automatically switch between an active mode and a passive mode of operation. In some embodiments, the multimedia device 104 may be configured to switch between the passive mode and the active mode based on location and/or user information. When operating in the passive mode, the user may have minimal control over the operation compared to an active mode of operation. Each of the number of external observers 110a-n in the present location 112 of the multimedia device 104 and/or the wireless display device 108 may transmit a user data (e.g., user identification information) to the multimedia device 104 in operation 202. In one embodiment, transmission may be a broadcast. In one embodiment the transmission may be through a request response model as mentioned earlier. In some embodiments, the wireless display device 108 may transmit a display location (e.g., present location of the wireless display device 108, a demographic information associated with the present location of the wireless display device 108, etc.) in operation 204. In one or more embodiments, in operation 206 the multimedia device 104 may receive the user data and display location. In operation 206 the multimedia device may transmit the user data, the display location and a device location (e.g., present location of the multimedia device 104, a demographic information associated with the present location of the multimedia device 104, etc.) to the advertisement server 106. The advertisement sever 106 generates a media data that is customized based on the data (e.g., the user data, the display location and a device location) received from the multimedia device 106 in operation 208. The advertisement sever 106 may also transmit the media data to the multimedia device 104 in operation 208. In some embodiments, the advertisement sever 106 may transmit the media data to the wireless display device 108. In operation 210, the media data from the advertisement server is received by the multimedia device 104. In one or more embodiments, the multimedia device nearly simultaneously communicates the media data to the wireless display device 108 in operation 212. In operation 214, the wireless display device 108 receives the media data and communicates the media data to the number of external observers 110a-n in operation 216. The wireless display device 108 may communicate the media data through displaying the media data. In operation 218, the multimedia device 104 may transmit the transaction information 218 associated with the media data communicated to the number of external observers 110a-n through the wireless display device 108. In some embodiments, operation 214 and operation 218 may occur nearly simultaneously.

The number of external observers 110a-n may use the transaction information in operation 220. In one or more embodiments, the advertisement server 106 may provide a consideration to the owner of the multimedia device 104 based on at least of a number of impressions of the a number of impressions of the media data rendered on the wireless display device 108 to the number of external observers 110a-n through the multimedia device 104 of the owner 102 and/or an interaction between at least one of the number of external observers 110a-n and a commercial entity based on a desired behavior marketed by the commercial entity associated with the media data communicated through the multimedia device 104 of the owner 102. In one or more embodiments, in the passive mode the advertisement server may push content (e.g., media data) to the multimedia device 104. The content may be based on the set of characteristics associated with the present location and/or the future location of the multimedia device 104. In some embodiments, the content may be based on the set of characteristics associated with the present location and/or the future location of the wireless display device 108. The multimedia device 104 may pre-cache the content (set of media data) in a buffer module of the multimedia device to have seamless content display when a network is broken, to reduce bandwidth consumption and optimize power consumption in the passive mode.

In some embodiments, the owner 102 of the multimedia device 104 may enter a preference of the owner through a user interface on the multimedia device 104. The user interface of the multimedia device 104 may allow the owner to add a preferred feature that needs to be considered when the advertisement server 106 generates a media data. The owner 102 may also request to access the advertisement server 106 to select a media data to be communicated to the number of external observers 110a-n. In some embodiments, the advertisement server 106 may grant an access to the data base to the owner. In certain embodiments, the owner 102 may have to enter a unique identification information through the user interface of the multimedia device to gain access to the database of the advertisement server 106. In another embodiment of FIG. 2, in operation 210, the multimedia device 104 may pre-cache a set of media data. In some embodiments, the owner 102 of the multimedia device may select a media data to be communicated to the number of external observers 110a-n. The owner 102 of the multimedia device 104 may select the media data from the set of media data pre-cached in the multimedia device 104. The owner 102 of the multimedia device 104 may select the media data through the user interface of the multimedia device 104.

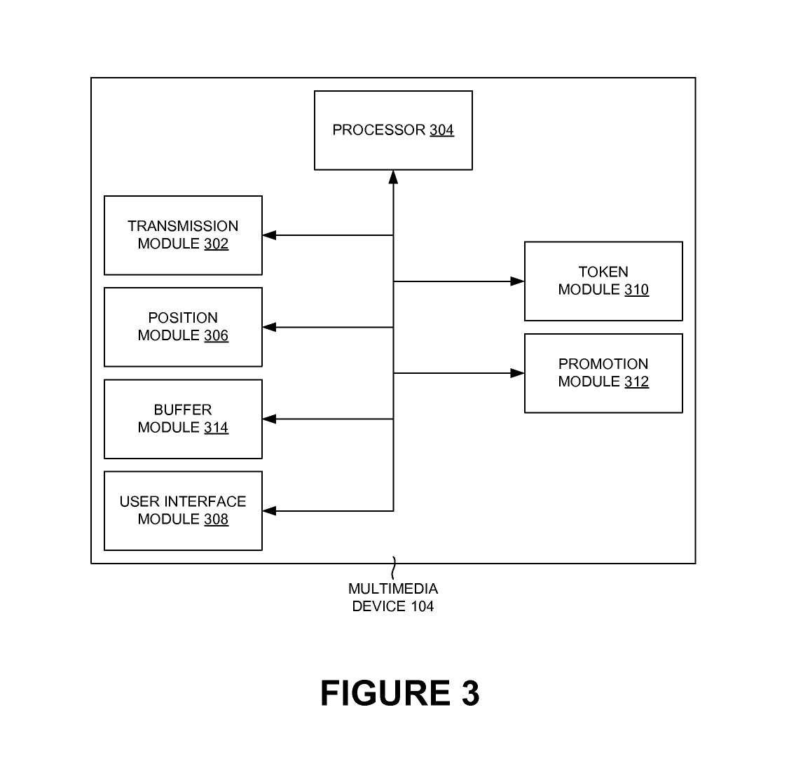

FIG. 3 is an exploded view illustrating the multimedia device of FIG. 1, according to one or more embodiments. In particular, FIG. 3 illustrates a transmission module 302, a processor 304, a positioning module 306, user interface module 308, a token module 310, a promotion module 312 and a buffer module 314.

In one or more embodiments, the transmission module 302 may be an I/O interface. The transmission module 302 may be a hardware interface and/or a software interface module. In some embodiments, the I/O interface may be a wireless interface. In certain embodiments, the I/O interface may be a wired interface. The transmission module 302 may be configured to operate as a transceiver module. The transmission module 302 may be coupled to the other modules of the multimedia device either directly or indirectly. In one or more embodiments, the transmission module 302 of the multimedia device 104 may be configured to receive the media data from the advertisement server 106. The transmission module 302 may be configured to communicate the media data to the number of external observers 110a-n through the wireless display device 108. The transmission module 302 may be configured to transmit the media data or a portion of the media data to the wireless display device 108. In some embodiments, the transmission module 302 may be configured to nearly simultaneously transmit the media data to the wireless display device while is receives the media data from the advertisement server. In certain embodiments, the transmission module 302 may be configured to synchronize the rate of data transmission with a refresh rate of the wireless display device before the media data is communicated to the number of external observers 110a-n.

In one or more embodiments, the transmission module 302 may be configured to receive a user identification information from the external observers 110a-n when the external observers 110a-n are in a communicative range of the multimedia device 104. The transmission module 302 may be configured to receive the user identification information through scanning for external observers 110a-n in a proximity of the multimedia device. In another embodiment, the transmission module 302 may receive the user identification information through requesting the communication devices associated with the external observers 110a-n for a user information. In some embodiments, when the external observers 110a-n have the client side application installed on a communication device 650 associated with the external observers 110a-n, then the client side application automatically sends a user identification information to the multimedia device when the external observer is in the communicative range of the multimedia device or vice-versa. The transmission module 302 may transmit a transaction information associated with media data. The transmission module 302 may receive the transaction information from the token module 310.

In one or more embodiments, the transmission module 302 may forward the media data received from the advertisement sever 106 to the user interface module 308 to display the media data to the owner through a user interface of the multimedia device 104 through the processor 304. The transmission module 302 may forward the media data and/or the transaction information associated with the media data to the promotion module 312 to publish the media data and/or the transmission information associated with the media data in a social media network (e.g., social media site/website) and/or a blogging platform (e.g., blog sites like Twitter) through processor 304. The media data may be stored in a buffer module 314. In one embodiment, the buffer module 314 may be a database. In one embodiment, the buffer module 314 may be a random access memory. In one embodiment, the buffer module may be a volatile memory. In one embodiment the buffer module may be a non-volatile memory. In one or more embodiments, the transmission module 302 may receive an information associated with a present location of the multimedia device 104 from the positioning module 306 of the multimedia device. In some embodiments, the transmission module 302 may receive a display location (e.g., present location of the wireless display device 108, a demographic information associated with the present location of the wireless display device 108, etc.).

In one or more embodiments, the positioning module 306 may be configured to determine a present location 112 of the multimedia device 104. The positioning module 306 may be configured to determine the present location 112 of the multimedia device 104 through a GPS, A-GPS, a network triangulation and/or through a check in information manually entered by the owner 102 of the multimedia device. In one or more embodiments, the positioning module 306 may also determine a set of characteristics associated with the present location 112 and/or future location 140 of the multimedia device 104. The positioning module 306 may be configured to determine a demographics information based on check in information associated with the present location 112 and/or future location 140. The positioning module 306 may also be configured receive demographic information from network service providers. The positioning module 306 may be configured to transmit the set of characteristics associated with the present location, future location and/or display location to the advertisement server through the transmission module 302. The positioning module 306 may be a hardware and/or software module.

In one or more embodiments, the token module 310 may receive a transaction information associated with the media data that is communicated to the external observers through the transmission module. The token module 310 may receive the transaction information from the advertisement server 106 through the transmission module 302. In some embodiments, the token module 310 may receive the media data from the transmission module. The token module 310 may generate a transaction information based on the media data received through the transmission module 302. The token module 310 may generate the transaction information through the processor 304. In one or more embodiments, the transaction information may be a virtual coupon, a bar code, a unique id associated with the media data. For example, the media data is an advertisement for a sale and the transaction information may a virtual coupon that can be downloaded on a communication device. The coupon may be used at a related store. The related store may be an online store and/or a physical store.

In one or more embodiments, the buffer module 314 may be configured to pre-cache a set of media data based on the set of characteristics associated with the present location and/or future location of the multimedia device 104, the owner's preference, etc. Pre-caching the media data may optimize a power consumption of the multimedia device 104. In one or more embodiments, the promotion module 312 may be configured to automatically publish the media data on social networking sites to engage another set of external observers that are not at the present location 112 of the multimedia device 104. The media data may be published on a social network profile page of the owner 102 of the multimedia device 104. The promotion module 312 may also publish a transaction information associated with the media data. In some embodiments, the owner 102 of the multimedia device 104 may select the media data to be published. In one embodiment, the promotion module 312 may form a group between the owner of the multimedia device and another owner of another multimedia device. In one embodiment, the promotion module 312 may form a group between the plurality of the external observers that have registered to avail the service associated with the multimedia device and/or the advertisement server and the owner of the multimedia device 104. In another embodiment, the promotion module 312 may form a group between the plurality of the external observers that have registered to avail the service associated with the multimedia device and/or the advertisement server 106. In one embodiment, the promotion module 312 of the multimedia device communicates the media data and/or the transaction information associated with the media data to either one of the group mentioned above between the owner of the multimedia device, another owner of another multimedia device and/or at least one of the plurality of the external observers. In one embodiment, the owner 102 of the multimedia device 104 may manually choose to communicate the media data and/or the transaction information associated with the media data to the members of the group formed between the owner 102 and other owners of other multimedia devices and/or the plurality of external observers in the group associated with the owner 102 of the multimedia device 104. In one embodiment, the promotion module 312 of the multimedia device may be configured to automatically communicate the media data and/or the transaction information associated with the media data to the members of the group formed between the owner 102 and other owners of other multimedia devices and/or the plurality of external observers 110 in the group associated with the owner 102 of the multimedia device 104.

In one embodiment, the group may be a web based group that may be of the form of a social networking platform and/or a blog platform. In one embodiment, activities associated with the media data and the transaction information of a member of the group may be viewable to another member of the group based on privacy settings of the member that is controllable by the member of the group.

In one or more embodiments, the owner 102 of the multimedia device 104 may interact with the advertisement server 106 and/or the external observers 110a-n through the multimedia device 104 via a user interface of the multimedia device 104. The owner 102 of the multimedia device 104 may enter a preference of the owner and/or choose a media data to be communicated to the external observers through the user interface of the multimedia device 104. The user interface module 308 may collect the data entered through the user interface and analyze the data through the processor 304. The user interface module 308 may customize the user interface based on data entered by the owner 102 through the processor 304.

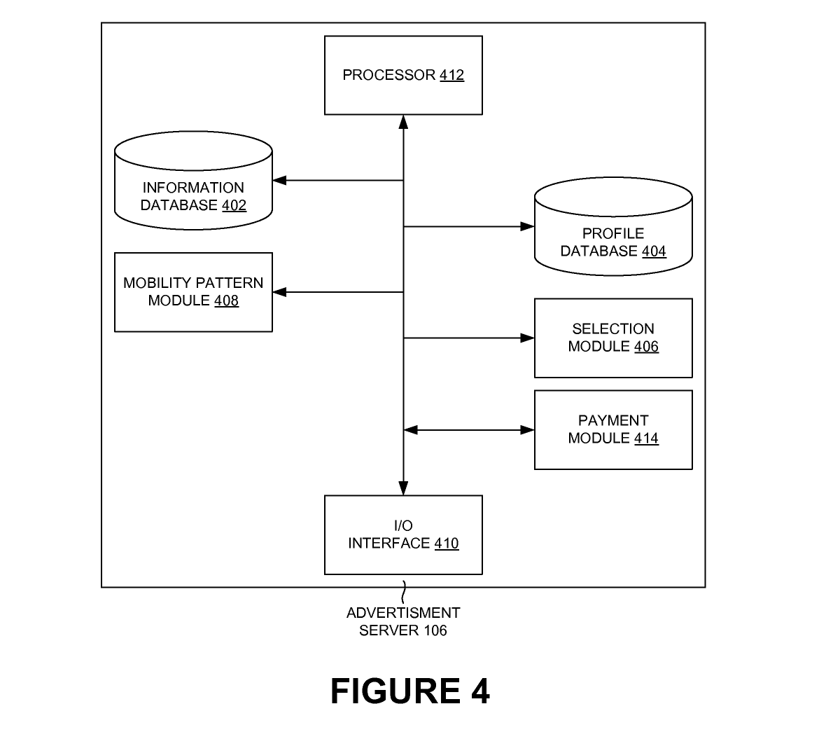

FIG. 4 is an exploded view illustrating the advertisement server of FIG. 1, according to one or more embodiments. In particular FIG. 4 illustrates an information database 402, a profile database 404, a selection module 406, a mobility pattern module 408, an I/O interface 410, a processor 412 and/or a payment module 414.

In one or more embodiments, the information database 402 may include a number of media data. The media data may be, but not limited to, an advertisement, a promotional video and/or an infomercial, a commercial video and/or awareness video. The media data may include dynamic display content and/or static display content. For example, the dynamic display content may be a video content, an audio content and/or an audio-visual content associated with an advertisement. In some embodiments the media data may be organized in the information database. The media data may be organized based on inter alia a demographics, a location, a type of behavior marketed through the media data, a brand name and/or a commercial entity associated with the media data. In certain embodiments, the media data in the information database 402 may not be organized. The media data may include tags that may be used to select the media data based on a variety of categories. In one embodiment, the media data may be selected based on a size, a length of time, a resolution and/or a user rating of the media data. In one or more embodiments, the information database 402 may be edited to add, delete, change content etc. The information database 402 may be edited remotely and/or through the I/O interface 410 of the advertisement server 106.

In one or more embodiments, the profile database 404 may include a user profile information. The user profile information may be an information associated with the owner 102 and/or the number of external observers 110a-n who have installed the client side application. Each user may be associated with a unique user identification information. In one or more embodiments, the profile database may include a username and a password associated with each user. The users profile information may be accessed through the multimedia device 104 and/or a device associated with the external observers 110a-n when a username and password entered by the owner 102 and/or external observers 110a-n match the username and password associated with the profile that is being accessed. In one embodiment, the user profile information may be accessed through other secure mechanisms such as bio scans of eye, retina, finger print etc. In another embodiment, the access could be through some pattern identification. In one embodiment, the user profile information may be accessed through a speech pattern recognition. In some embodiments, the profile database 404 may include a user behavior, user purchase pattern, favorites section etc. The profile database may be edited remotely and/or through the I/O interface.

In one or more embodiments, the mobility pattern module 408 may determine a future location of a multimedia device 104 based on set of previous locations and present location 112 of the multimedia device 104. The mobility pattern module 408 may include a memory (not shown in FIG. 4). In one embodiment, the mobility pattern may also be determined through tracking a motion of the multimedia device 104 and/or the wireless display device 108. The tracking may be continuous and/or discrete. The present location 112 and the previous locations of the multimedia device 104 may be stored in the memory. The memory may be a static and/or dynamic memory. Various mobility prediction algorithms may be stored in the memory. The mobility pattern module 408 may receive the present location and/or previous location information of the multimedia device 104 from the multimedia device 104, the external observers 110a-n and/or network service providers. In one or more embodiments, the mobility pattern module 408 may provide the present location, speed of motion, and direction of motion of the multimedia device and/or the previous location information of the multimedia device 104 to the mobility prediction algorithm to generate a prediction of a future location of the multimedia device 104 through the processor 412. In some embodiments, the owner of the multimedia device may set a destination and a start location. The destination location may be considered as the future location relative to the start location. The location information may be provided to the selection module 406.

In one embodiment, the mobility pattern module 408 may be configured to generate an spatial analytics data based on the set of characteristics associated with the present location and/or future location of a number of multimedia devices in the present location and/or future location of the wireless display device 106 and/or a user information associated with the plurality of external observers 1101-n. In one embodiment, the spatial analytics data may also be generated based on information obtained from any one multimedia device 104 available at a location. In one embodiment, the spatial analytics data may also be based on information obtained from a third party source. In one embodiment, the set of characteristics associated with the present location and/or future location of the multimedia device 104 and/or the wireless display device 106 used to generate the spatial analytics data may be provided to the advertisement server 106 through the multimedia device 104 and/or wireless display device 108. In one embodiment the spatial analytics data may include inter alia information of the type of external observers, affinities of the external observers, an age of the external observers, income of the external observers etc., in the present location of a multimedia device 104. In an example embodiment the mobility pattern module 408 may generate a spatial diversity data for a whole geographical area which may be retrieved by an owner 102 of a multimedia device 104 on request. In the example embodiment, the advertisement server 106 may alert an owner 102 about the presence of a group of external observers in the proximity of the owner 102.

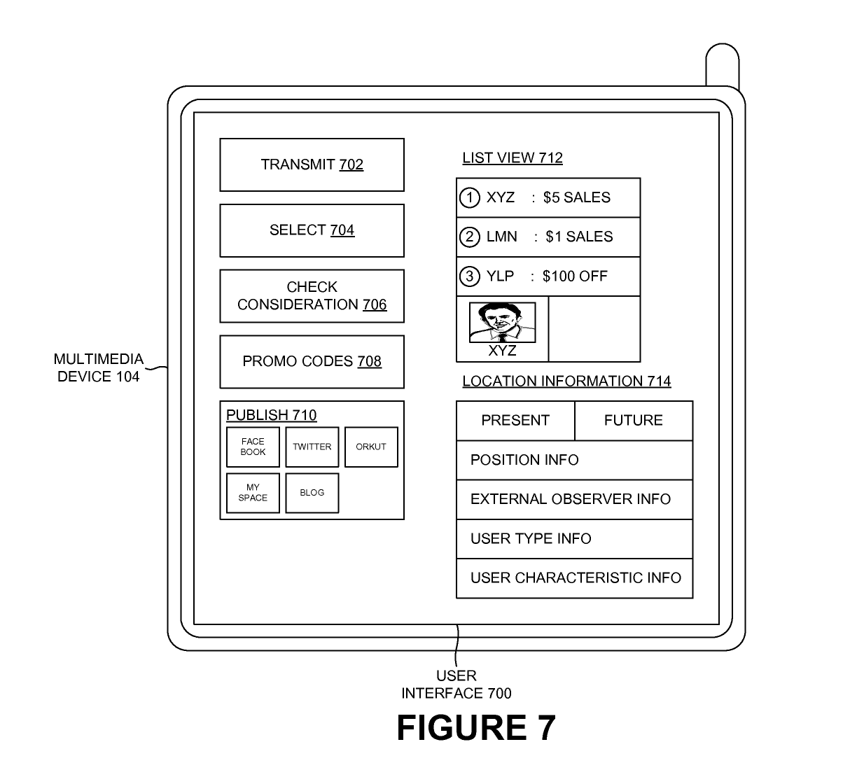

In one embodiment, the spatial analytics data may be representable in the form of an interactive map. In one embodiment, the interactive map based on the spatial analytic data may be displayed on a user interface of the multimedia device 104. In an example embodiment, this facility may be provided as an additional service to the owner 102 of the multimedia device 104. An example embodiment of the user interface associated with the multimedia device 104 may be described in FIG. 7.

In one or more embodiments, the selection module 406 may receive a set of characteristics associated with a present location 112 and/or future location 140 of the multimedia device 104. The set of characteristics associated with the location of the multimedia device 104 may be obtained from the multimedia device 104, the owner 102, the external observers 110a-n, network service providers and/or social media. In one more embodiments, the set of characteristics associated with the present location 112 and/or the future location 140 of the multimedia device 104 includes the geo-spatial location the multimedia device, demographic diversity of the present location 112 and/or future location 140 of the multimedia device 104, a spatial diversity of the location of the multimedia device 104, a time of the day, a season of the year and a diversity of a type of establishment in the present location 112 and/or future location 140 of the multimedia device 104. The selection module 406 may generate a media data based on the set of characteristics associated with the present location 112 and/or the future location 140 of the multimedia device 104. In one embodiment, the set of characteristics associated with the present location 112 of at least one of the multimedia device 104 and the wireless display device 108 may include a user information associated with the plurality of external observers in the present location of the multimedia device 104 and/or the wireless display device 108. In one embodiment, if the plurality of external observers in the present location 112 of at least one of the multimedia device and the wireless display device may changes dynamically to a different set of external observers with respect to time, the multimedia device and/or the wireless display device may detect the change in the plurality of external observers. In one embodiment, the multimedia device may calculate a new set of characteristics associated with the present location of the multimedia device and/or the wireless display device based on the change in the plurality of external observers. For example, in a mall the number of people as well as the people itself at a given location at the mall may keep changing with respect to time. If an owner 102 of the multimedia device 104 may be at location X in the mall at 2 pm and there may be 10 external observers in the proximity of the multimedia device 104. If he checks at 7 pm there may an entirely new group of 20 external observers in proximity of the multimedia device 104 that may or may not include the 10 external observers that were in the proximity of the multimedia device at 2 pm. The multimedia device 104 dynamically changes the set of characteristics that it transmits to the advertisement server 106 based on the change in the external observers in a proximity of the multimedia device 104 since the set of characteristics also depend on the external observers around the multimedia device 104.

The selection module 406 may receive a user identification information from the multimedia device 104. The user identification information may be associated with the number of external observers 110a-n who has installed the client side application. The user identification information may be unique to each external observer who has installed the client side application. The selection module 406 may access the profile database 404 to access a user profile information based on the user identification information. The selection module 406 may match a user identification information with a user profile stored in a profile database of the advertisement sever to generate a media data based on a user behavioral pattern. The selection module 406 may search the information database 402 based on the user profile information received from the profile database 404. The selection module may select relevant media data based on the set of characteristics associated with a user, present location 112 and/or future location 140. The selected media data may be the media data which is customized based on the selection thereof. The media data may then be transmitted to the multimedia device 104 and/or the wireless display device 108.

In some embodiments, the media data may be customized based on the set of characteristics associated with the present location 112 and/or the future location 140 of the wireless display device 108. In one or more embodiments, the selection module 406 may generate the transaction information associated with the media data. In one embodiment, the transaction information may be generated through the processor of the multimedia device. In one embodiment, the multimedia device 104 may identify the media data and generate a appropriate transaction information through the token module 310 of the multimedia device. The transaction information may be transmitted to the multimedia device 104 and/or wireless display device 108 through the I/O interface. In one or more embodiments the transaction information may be stored in the information database. The payment module 414 may determine a consideration to be provided to the owner 102 of the multimedia device 104 based on a number of impressions of the media data portrayed through the multimedia device 104 and/or based on the use of the transaction information. In one or more embodiments, the transaction information may be unique to each owner 102 and each media data. In one embodiment, the transaction information may be unique to each external observer, per owner per media data. In another embodiment, the transaction information may be unique to each external observer; per owner per media data per wireless display device. The unique transaction information may allow the advertisement server to determine the rightful delivery of the consideration. In an example embodiment, the consideration may be divided between the owner 102 of the multimedia device and/or an owner of the wireless display device if the owner 102 of the multimedia device is different from the owner of the wireless display device. The media data communicated through the multimedia device 104 may be determined through the transaction information. In some embodiments, the multimedia device 104 and the owner of the multimedia device 102 that communicates the media data may be identified through the transaction information.

In one or more embodiments, the payment module 414 may be configured to provide a consideration to the owner 102 of the multimedia device 104. In some embodiments, the owner 102 of the multimedia device 104 and the wireless display device 108 may be different. The payment module 414 may be configured to provide a consideration to the owner of the wireless display device. The consideration may be a monetary consideration. The consideration may be provided proportional to a value of targeting in a particular geospatial area based on the number of impressions of the media data rendered on the wireless display device 108 to the plurality of external observers through the multimedia device of the owner and/or the interaction between at least one of the plurality of external observers 110a-n and a commercial entity based on a desired behavior marketed by the commercial entity associated with the media data communicated through the multimedia device 104 of the owner. The payment module 414 may associate an owner 102, the multimedia device 104 of the owner 102 and/or the wireless display device 108 through which the media data is communicated to the number of external observers 110a-n with the transaction information. The transaction information may be unique to the owner 102, the multimedia device 104 and the media data. The payment module 414 may also provide a consideration based on number of transaction information collected by the external observers 110a-n, the number of collected transaction information shared with other external observers, number of page visits of a commercial entity based on the transaction information associated with the media data and/or the number of collected transaction information and/or media data that is converted to a purchase.

In one or more embodiments, the I/O device may be a wired interface and/or a wireless interface. The advertisement server 106 may be communicatively coupled to multimedia device and/or the wireless display device through the I/O interface.

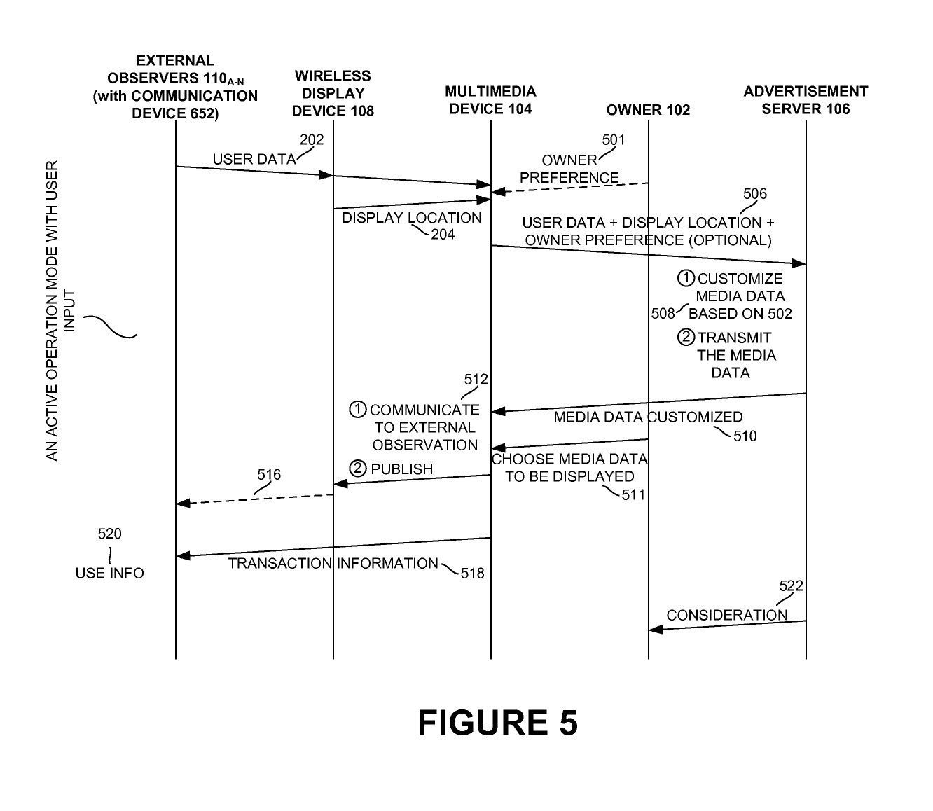

FIG. 5 is a process flow view of FIG. 1 illustrating the advertisement server, the multimedia device and the wireless display device communicating media data to external observers in an active mode of operation, according to one or more embodiments. In an active mode of operation the owner 102 of the multimedia device 104 may include a preference of the owner 102 in customizing and/or communicating the media data displayed to the external observers 110a-n. In one embodiment, the user may select from a list of media data cached on the multimedia device 104. The owner 102 of the multimedia device 104 may express the preferences of the owner 102 through a user interface (e.g., location information tab 714) associated with the multimedia device 104. An example embodiment of the user interface is described in FIG. 7.

In one embodiment, each of the number of external observers 110a-n in the present location 112 of the multimedia device 104 and/or the wireless display device 108 may transmit a user data (e.g., user identification information) to the multimedia device 104 in operation 202. In some embodiments, the wireless display device 108 may transmit a display location (e.g., present location of the wireless display device 108, a demographic information associated with the present location of the wireless display device 108, etc.) in operation 204. In the active mode of operation, in some embodiments the owner 102 of the multimedia device 104 may enter a preference of the owner (e.g., owner preference) in operation 501. Entering a preference of the owner may be optional. In one embodiment, in operation 506 the multimedia device 104 may transmit the user data, the display location, a device location (e.g., present location of the multimedia device 104, a demographic information associated with the present location of the multimedia device 104, etc.) and/or a preference of the owner 102 to the advertisement server 106. The advertisement sever 106 may generate a media data that is customized based on the data (e.g., the user data, the display location and a device location) received from the multimedia device 106 in operation 508. The advertisement sever 106 may also transmit the media data to the multimedia device 104 in operation 508. In some embodiments, the advertisement sever 106 may transmit the media data to the wireless display device 108. In operation 510, the media data from the advertisement server is received by the multimedia device 104.

In one embodiment, in operation 511 the owner 102 of the multimedia device 104 may choose from the media data received through a user interface of the multimedia device 104. In one embodiment, the owner 102 may browse through the media data received and may choose not to communicate the media data to the external observers through either publishing it or through the wireless display device 108. In one embodiment, if there are a number of media data to select from, the owner 102 of the multimedia device 104 may select a media data based on the preference of the owner 102 to display through the wireless display device 108. In one embodiment, in operation 511 the owner 102 of the multimedia device 108 may choose to publish the media data on number of social networking service platform and/or blogging platform to communicate the media data to another plurality of external observers. In one embodiment, the other plurality of external observers may be in a location different from the present location of the multimedia device. In one embodiment, the other plurality of external observers may be within the present location as well. In one embodiment, when the owner 102 chooses to publish the media data the user interface module 308 may arrange or customize the media data to fit to a page specification of the publishing sites. In one embodiment, the media data and/or the transaction information associated with the media data may be delivered to other external observers through inter alia a web based mail (e.g., email) and/or SMS. In one embodiment, the owner 102 of the multimedia device may be able to access the features and/or modules of the advertisement server through a web based user interface. The web based user interface may be accessible through a generic computer, a PDA and/or a mobile multimedia device.

In one or more embodiments, operations 512-522 may be similar to corresponding operations 212-222 of FIG. 2.

FIG. 6 is a system view of an advertisement server, a multimedia device and a wireless display device communicating media data to external observers including publishing, according to one or more embodiments. In particular, FIG. 6 focuses on the feature where the multimedia device 104 may share the media data through publishing the media data through a promotion module 312 of the multimedia device 104 on a number of social networking service platforms and/or blogging platform to communicate the media data to another number of external observers 604 that may be in a location different 606 from the present location 112 of the multimedia device 104. In one embodiment, the other number of external observers 604 may be within the present location 112 of the multimedia device 104. In one embodiment, the media data may be published nearly simultaneously as it is being communicated to the external observers through the wireless display device 108. In one embodiment, the media data may be published after or before the media data is communicated to the external observers 110a-n through the wireless display device 108. In one embodiment, the media data may be visually and/or substantively customized before publishing through a user interface module 308 of the multimedia device to fit to the requirements of the publication site. In one embodiment, the social networking service platforms and/or blogging platform on which the media data is published may be associated with the owner 102 of the multimedia device 104. In one embodiment, the media data may be published on the social networking service platforms and/or blogging platform of the owner's friend. In one embodiment, the media data may be published on a blogging platforms associated with the content of the media data.

In an example embodiment of FIG. 6 the user information of the external observers may be received through the multimedia device when the external observers are within a communicative range of the multimedia device when at least one of the plurality of the external observers has a client side instance of a service associated with the multimedia device 104 and/or the advertisement server 106. In one embodiment, it is assumed that each one of the plurality of external observers 110 may have a communication device 650 with them. In one embodiment, the user information may be retrieved through the communication device 650 associated with each one of the plurality of external observers 110. In one embodiment, the plurality of external observers 1101-n, may include external observers that have registered to receive a service associated with the multimedia device 104 and/or the advertisement server 106 and external observers that have not registered to receive the service. In one embodiment, on registering to receive the service the external observer may download or install a client side software or client instance 652 of the service that is associated with the multimedia device 104 and/or the advertisement server 106. The terms client side instance, client software and client application may be used interchangeably and may not be considered as a limitation. All three terms refers to the client instance 652 on a communication device 650 associated with the external observers. In one embodiment, the external observer can obtain the client side features even without downloading the instance. In this scenario, the external observer may access the features through the advertisement server. In one embodiment, the service associated with the multimedia device and/or the advertisement server 106 may be the service of displaying the media data (e.g., advertisement) based on the geospatial location to a plurality of external observers through the multimedia device 104 based on a set of characteristics associated with the present location and/or future location of the multimedia device and/or wireless display device and providing a consideration to the owner 102 of the multimedia device 104 based on certain criterion. In one embodiment, the server instance of the service may be implemented on the advertisement server 106, the multimedia device 104 and/or distributed between both the multimedia device 104 and the advertisement server 106.

In one embodiment, if the external observer has client side software or a client instance 652 installed or present on the communication device 650 associated with the external observer, then the multimedia device 104 and/or advertisement server 106 may automatically retrieve the user information associated with the external observer. However, if the external observer does not have client instance 652 present on the communication device 650 associated with the external observer and the external observer is not registered to receive a service associated with the multimedia device 104 and/or the advertisement server 106 then the multimedia device 104 may have to send a request to the external observer to receive the user information associated with the external observer. In one embodiment, as mentioned earlier the multimedia device 104 may obtain user information of all external observers in the present location and or future location of the multimedia device 104 and the wireless display device 108 through a third party source (e.g., network service provider, social network sites, blogging sites etc.).

In one embodiment, the client instance 652 of the service that is associated with the multimedia device 104 and/or the advertisement server 106 that is present on the communication device 650 associated with the at least one of the plurality of external observers 110 may be configured to automatically retrieve the media data and/or the transaction information associated with the media data through the communication device 650 when the communication device 650 associated with the at least one external observer 110 is in a communicative range of the multimedia device 104 and/or the wireless display device 108 through which the media data and/or the transaction information associated with the media data is communicated.

In one embodiment, the client instance 652 of the service that is associated with the multimedia device 104 and/or the advertisement server 106 that is present on the communication device 650 associated with the at least one of the plurality of external observers 110 may be configured to retrieve the media data and/or the transaction information associated with the media data through the communication device 650 when the at least one external observer 110 manually chooses to collect the media data and/or the transaction information associated with the media data and the communication device 650 associated with the at least one of the plurality of external observers 110 is in a communicative range of the multimedia device 104 and/or the wireless display device 108 through which the media data and/or the transaction information associated with the media data is communicated.

In one embodiment, the transaction information associated with the media data and the media data may be retrieved automatically and/or manually by the at least one external observer 110 through a communication device 650 of the external observer when the communication device 650 associated with the external observer is in a communicative range of the multimedia device and/or wireless display device that communicates the media data and/or the transaction information associated with the media data. In one embodiment, the retrieval mode may be through a wired or wireless medium. In one embodiment, the retrieval mode may be through a text message and/or a gesture based mechanism. In an example embodiment, the external observer may be driving around a present location of the multimedia device and/or wireless display device. The external observer may not want to manually access the communication device 650 to collect the transaction data associated with a media data that the external observer saw through the wireless display device. The client instance 652 on the communication device 650 of the external observer may be configured to automatically retrieve the media data and/or the transaction information associated with the media data. The format of the media data and/or the transaction information may be compatible to the form factor of a display of the communication device. The media data and/or the transaction information may be stored in a memory module of the communication device 650 associated with the external observer. In one embodiment, the communication device 650 may alert the external observer of a media data associated with time sensitive deals based on a configuration of the client instance present in the communication device 650. The client instance 652 may be configured based on the external observer's preference. In one embodiment, the advertisement server 106 may generate a list of media data relevant to a future location of the external observer 110. The advertisement server 106 may transmit the list of the relevant media data to the communication device associated with the external observer. In one embodiment, the future location of the external observer 110 may be determined through a location input provided by the external observer 110. In one embodiment, the external observer may access the list of relevant media data through accessing the advertisement server 106 via a web interface associated with the advertisement server 106. In one embodiment, the advertisement server may be accessed through the communication device 650. The media data and/or the transaction information may be stored in the form of a playlist of media data that may be accessible by the external observer as desired. The client instance 652 may be configured to automatically retrieve media data that is relevant to the external observer. The external observer may share the list with another group of external observers as desired. In one embodiment, the external observer 110 may edit (e.g., add, delete, create a new list, add comments) the list before sharing it with the other group of external observers. In one embodiment, the external observers that share the playlist with other external observers may receive a consideration from the payment module of the advertisement server when the other group of external observers use the transaction information and/or have seen the transaction information and/or media data.

In one embodiment, the plurality of external observers may retrieve the transaction information and/or the media data through a social networking platform and/or a blogging platform to which the multimedia device may publish 602 the media data and/or the transaction information associated with the media data. In one embodiment, the social networking platform and/or the blogging platform may be web based platform. In one embodiment, the transaction information and/or the media data may be published, inter alia in the form of an RSS feed, atom, xml and/or other syndication feeds.

In one embodiment, the user identification information may be transmitted to the advertisement server. In one embodiment, the media data may be customized based on a user behavioral pattern through matching a user identification information with a user profile stored in a profile database of the advertisement sever. In one embodiment, the media data may be customized based on the user profile and a set of characteristics associated with a present location of the multimedia device. In one embodiment, the media data may be customized based on a user profile, a set of characteristics associated with the present location and/or future location of the multimedia device. In one embodiment, the media data may be customized based on a user profile, a set of characteristics associated with the present location and/or future location of the multimedia device and a preference of the owner. In one embodiment, the media data may be customized based on a user profile, a set of characteristics associated with the present location and/or future location of the multimedia device, a preference of the owner and/or the location of the wireless display device 108.

In one embodiment, the advertisement server 106 may customize the data. In one embodiment, the media data that is customized may be received by the multimedia device 104. In one embodiment, the media data may also be customized to fit a form factor of a communication device 650 associated with the external observer 110. The multimedia device 104 may nearly simultaneously communicate the media data to the external observers through the wireless display device 108. In one embodiment, the multimedia device 104 may publish 602 the media data automatically on a number of social networking service platforms and/or blogging platform to communicate the media data to another number of external observers 604 that may be in a location different 606 from the present location 112 of the multimedia device 104 along with communicating the media data to the external observers 110a-n through the wireless display device. In one embodiment, the other plurality/number of external observers 604 may be in the present location 112 of the multimedia device 104. In one embodiment, the multimedia device 104 may also transmit the transaction information associated with the media data along with the media data. The advertisement server 106 may provide a consideration to the owner 102 of the multimedia device 104 based on a number of impressions of the media data rendered on the wireless display device to the plurality of external observers through the multimedia device of the owner and/or an interaction between at least one of the plurality of external observers and an entity associated with the media data based on a desired behavior marketed by the entity through the media data communicated via the multimedia device of the owner.

FIG. 7 is an example embodiment of a user interface of the multimedia device of FIG. 1, according to one or more embodiments. In one or more embodiments, the owner 102 of the multimedia device 104 may interact with the multimedia device 104 through the user interface 700. The user interface may be accessed through a touch based action if the multimedia device supports a touchscreen operation. The user interface may also be accessed through a keypad associated with the multimedia device 104. In one or more embodiments, the user interface may include a transmit tab 702, a select tab 704, a check consideration tab 706, a promo code 708 tab, a publish tab 710, a list view tab 712 and/or a location information tab 714.

In one or more embodiments, the owner 102 of the multimedia device 104 may transmit the media data to the wireless display device through the transmit tab 702. In one embodiment, the transmit tab 702 may be used by the owner 102 of the multimedia device 104 to transmit the media data as a text message to a user that the owner prefers to send the media data. In one embodiment, the media data is an advertisement. In another embodiment, the media data is a promotional offer.

In one or more embodiments, the owner 102 of the multimedia device 104 may select a media data to be published and/or communicated via the wireless display device 108 through the select tab 704. In one embodiment, the owner 102 may select the media data from a list view 712 including a list of media data buffered in the multimedia device 104. In one embodiment, the list view 712 may display a list of media data buffered or pre-cached in the multimedia device 104. When the owner slides over or selects each element of the list view a detail of the media data selected may be displayed below the list as illustrated in FIG. 7. In one embodiment in the list view the media data may be customized to fit to the size restrictions of the multimedia device 104.

In one or more embodiments, the multimedia device 104 may display a location information 714 which includes a list of the values associated with a set of characteristics related to the present location and/or future location of the multimedia device 104. In one embodiment, the set of characteristics associated with the present location of the multimedia device may include the geo-spatial location the multimedia device, demographic diversity of the present location and/or future location of the multimedia device, a spatial diversity of the location of the multimedia device, a time of the day, a season of the year and/or a diversity of a type of establishment in the present location of the multimedia device. In one embodiment the set of characteristics associated with the future location of the multimedia device 104 may include the geo-spatial location the multimedia device, demographic diversity of the present location and/or future of the multimedia device, a spatial diversity of the location of the multimedia device, a time of the day, a season of the year and/or a diversity of a type of establishment in the present location of the multimedia device.

In one embodiment, the owner 102 of the multimedia device 104 may transmit a transaction information associated with the media data through selecting the promo code tab 708. The owner may choose to transmit the transaction information to the external observers 110a-n directly. In one embodiment, the owner 102 of the multimedia device 102 may manually select an option to transmit the transaction information. In another embodiment, the multimedia device 104 may be configured to automatically transmit the transaction information. The transaction information may be retrievable by the external observer 110a-n through a communication device 650 associated with the external observers configured to retrieve the transaction information. The communication device 650 of the external observer may be configured to automatically retrieve the transaction information and/or a media data without requiring any action of selection of retrieval of the said data by the external observer. In one embodiment, the external observer may choose to manually retrieve the transaction information and/or media data. In one embodiment the communication device 650 may be configured to automatically retrieve only specific transaction information and/or media data based on a user information and/or user profile of the external observer. In one embodiment, external observer may modify the said configuration. In one embodiment, the transaction information and/or media data may be broadcasted to a number of multimedia device and thereby to a number of external observers in the present location of each of the multimedia device and/or the wireless display device based on a request of the advertisement server. In one embodiment, the transmission of the media data to external observers through the wireless display device and/or the multimedia device may be controlled to fit a requirement of the advertisement server based on a request of the advertisement server. The transmission of the media data to the external observers through the multimedia device and/or the wireless display device may be controlled to be displayed every couple of minutes or display a certain number of times etc. In one embodiment, the advertisement server 106 may instruct the multimedia device 104 to override a transmission functionality of the multimedia device to respond to a request of the advertisement server when the advertisement server requests to transmit a media data of high priority (e.g., emergency information, missing person information) For example, if an emergency data of a missing person is to be transmitted, since this information would be considered as an emergency information, this information may be broadcasted to flood the network rather that a targeted transmission approach. In one example, the emergency data may be transmitted to the multimedia devices in a specific city or a state. The broadcast may be specific to a geo-spatial location. The device configured to retrieve the transaction information may have a client side application of the service associated with the multimedia device 104 and/or advertisement server 106. In one embodiment, the owner 102 of the multimedia device 104 may check or analyze the amount of consideration the owner 102 has received based on a number of impressions of the media data rendered on the wireless display device to the plurality of external observers through the multimedia device of the owner and/or an interaction between at least one of the plurality of external observers and an entity associated with the media data based on a desired behavior marketed by the entity through the media data communicated via the multimedia device of the owner through the check consideration 706 tab. The check consideration tab 706 may also display an analysis chart indicating the estimated consideration that the owner 102 could make based on the media data communicated through the multimedia device 104. In one embodiment, on selecting the check consideration tab 706, the multimedia device may provide a list of suggested media data that could generate the highest consideration for the owner 102 based on the set of characteristics associated with the present location and/or future location of the multimedia device 104.

In one embodiment, publish tab 710 may be communicatively coupled to the promotion module 312 of the multimedia device. The publish tab 710 may be initiate publication of the media data on multiple social networking and/or blogging platforms. In one embodiment, the media data to be published may be selected by the owner 102. In one embodiment, selecting the publish tab 710 may publish the media data nearly simultaneously over multiple social networking and blogging platforms. In one embodiment, the owner 102 may select the blogging platform or the social networking platform to publish the media data.

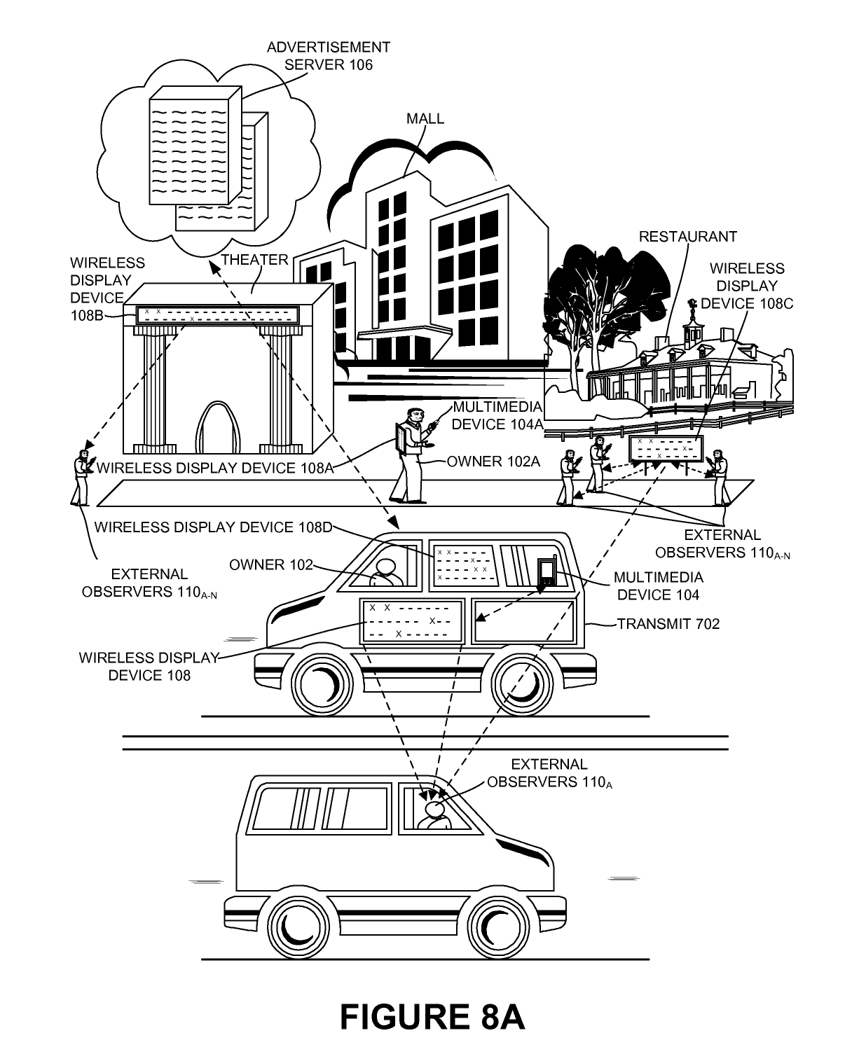

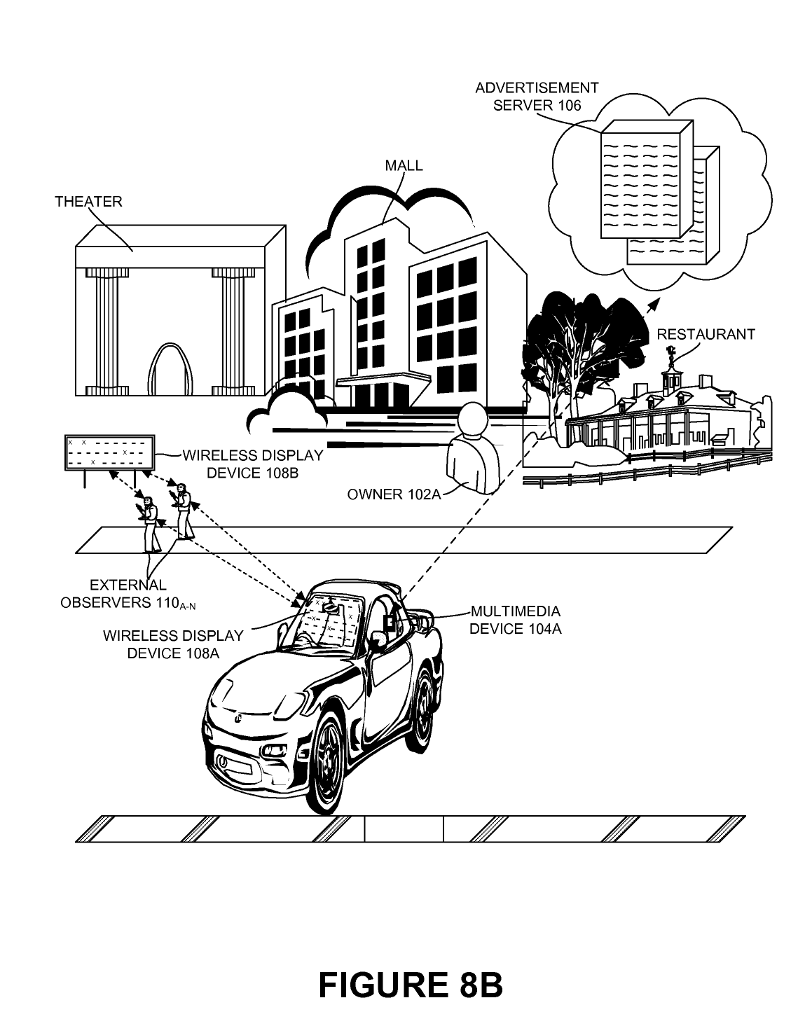

FIG. 8A is an example embodiment of communicating media data to external observers through the multimedia device when the multimedia device moves across multiple geospatial locations, according to one or more embodiments. In one embodiment, the multimedia device and the wireless display device may be coupled to a mobile medium 702. In an example embodiment illustrated in FIG. 8A the mobile medium 702 may be a vehicle. In one embodiment, the owner 102 of the multimedia device may be traveling in a vehicle and the owner 102 may have the multimedia device 104 with the owner. In one embodiment, the owner 102 may be at a different location. In one embodiment, the mobile medium 702 may be moving across multiple geo spatial location based on a speed of the mobile medium 702 to which the multimedia device 104 and/or the wireless display device 108 may be coupled to. The wireless display device 108 may adjust a rate of display or refresh rate of the media data being displayed through the wireless display device 108 based on a speed of motion of the mobile medium 702. In one embodiment, the rate at which the media data is displayed may be adjusted to a rate that is readable and perceivable by a normal human eye. The media data displayed through the wireless display device 108 may be communicated to the external observer 110a. In one embodiment, the external observer 110a may be in a different mobile medium as well. In another embodiment, the external observer 110a may not be mobile. In one embodiment, there may be a number of external observers 110a-n. In one embodiment, the multimedia device 104 and/or the wireless display device 108 may be communicatively coupled to the advertisement server 106 which may be located either at a remote location or in a proximity of the present location of the multimedia device 104. In one embodiment, a server application may be distributed over different computing devices.

In one embodiment, the media data that is displayed on the wireless display device may be dynamically changed while the wireless display device along with the multimedia device coupled to the mobile medium moves from one geo-spatial location to another geospatial location based on a motion of the mobile medium. In one embodiment, a rate of change between different media data displayed on the wireless display device may be associated with a rate of the motion of the mobile medium and/or a present location and/or a future location of the multimedia device and/or the wireless display device coupled to the mobile medium. In one embodiment, the media data may be received from the advertisement server through the multimedia device based on a set of characteristics associated with the present location and/or a future location of the multimedia device that is transmitted to advertisement server. In one embodiment, when the media data received from the advertisement server is a media data associated with a future location of the multimedia device and/or the mobile medium to which the multimedia device is coupled, the media data is buffered in the multimedia device which is displayed when the multimedia device and the wireless display device may be in a proximity of an appropriate location associated with the media data. The appropriate location may be within the future location of the multimedia device 104. In one embodiment, the promotion module may determine a temporal rate of change of different media data and/or a frame rate of each media data displayed on the wireless display device based on a form factor of the wireless display device and/or a display safety regulation.

In one embodiment, the multimedia device may pre cache a set of media data that are customized based on a present location and a future location of the multimedia device. In one embodiment, the pre caching may enable the multimedia device to communicate appropriate media date based on the appropriate location of a business or a location where the media data may be most effectively perceived to generate income based on the media data. In one embodiment, the mobile medium 702 may be the owner 102 of the multimedia device 104. In one embodiment, the owner 102 of the multimedia device 104 may have the wireless display device coupled to clothes worn by the owner of the multimedia device in such a way that it is perceivable to the external observers 110. In one embodiment, the external observers may couple the wireless display device 108 to a cloth worn by the external observer 110. In one embodiment, the mobile medium 702 may be any vehicle and/or moving object.

FIG. 8B is an example embodiment of communicating media data to external observers through the multimedia device when the multimedia device in an example geospatial location, according to one or more embodiments. In one or more embodiments, the wireless display device 108 may be coupled to a fixed medium. The fixed medium for example may be building, a window of an apartment, a fixed car in a parking lot as illustrated in FIG. 8B, a billboard etc. The multimedia device may be configured to communicate a relevant media data to a number of external observers 110a-n in a present location of the multimedia device 104 based on a set of characteristics associated with a present location of the multimedia device 104. In one embodiment, the multimedia device 104 may also communicate the media data to external observers 604 that are a location different and external from the present location of the multimedia device 104 through publishing the media data over a number of social networking platforms and/or blogging platforms associated with the owner 102 and/or users related to the owner 102 or the content of the media data.

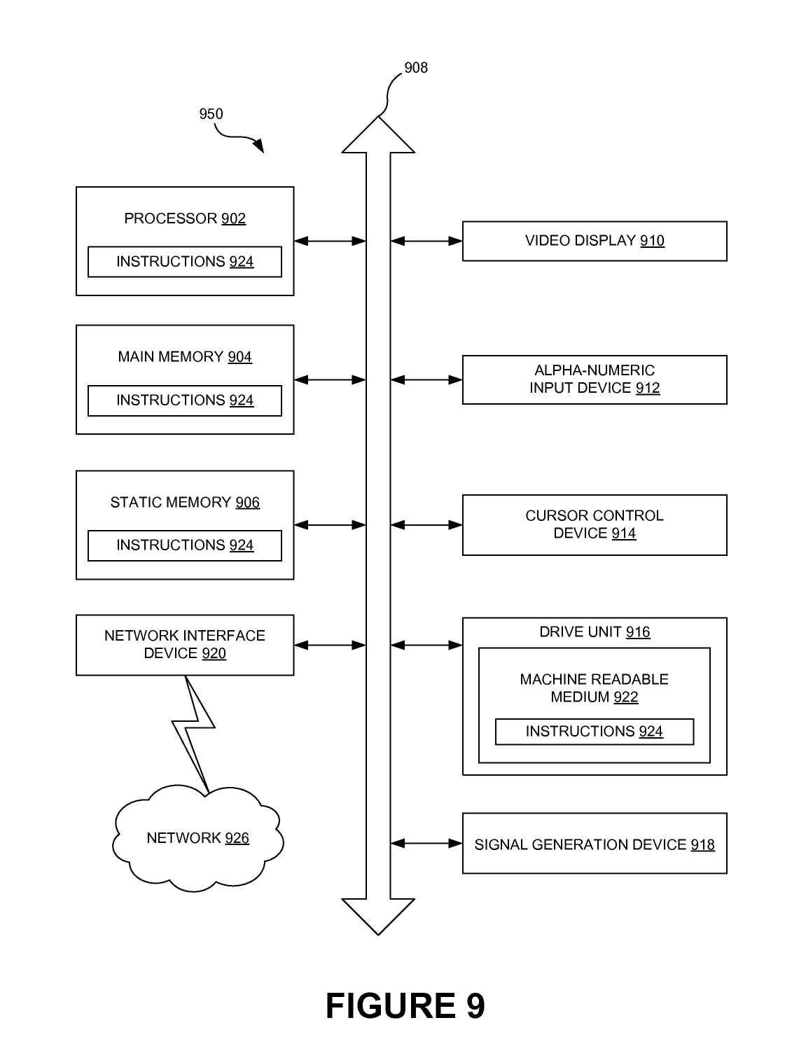

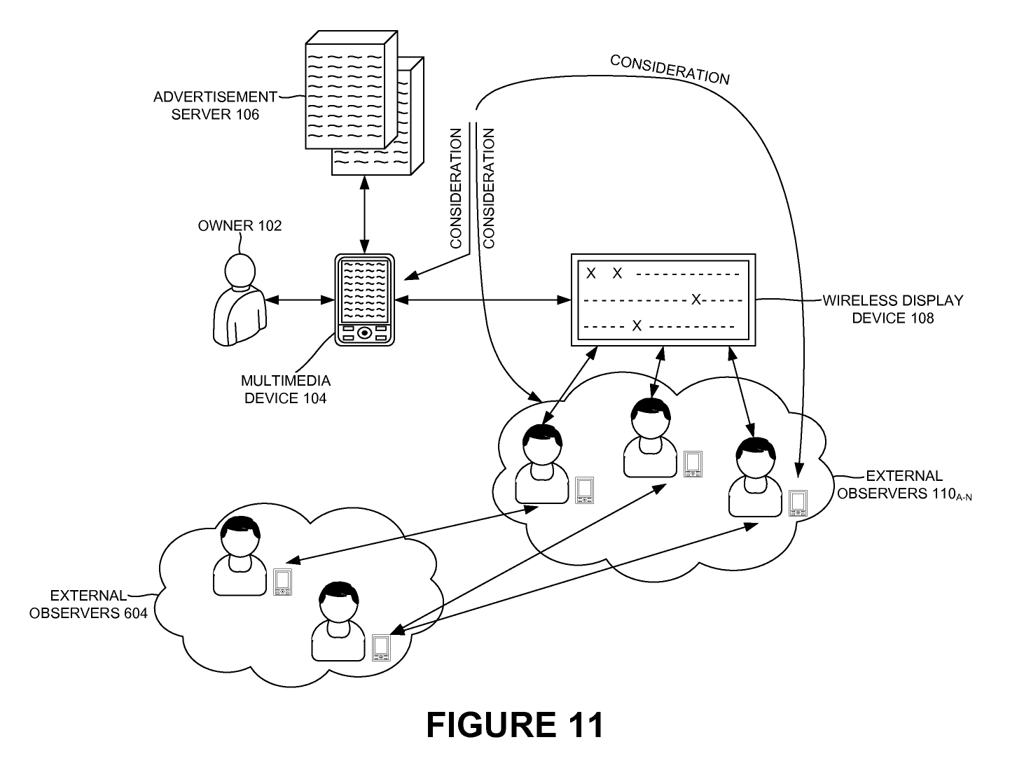

FIG. 9 is a diagrammatic representation of a data processing system capable of performing a set of instructions to perform any one of the methodologies herein, according to one or more embodiments. The components as described in the embodiment of FIG. 1 and FIG. 6 are used herein in reference to FIG. 11 for explanatory purposes. Particularly, the system view 950 of FIG. 11 illustrates a processor 902, a main memory 904, a static memory 906, a bus 908, a video display 910, an alpha-numeric input device 912, a cursor control device 914, a drive unit 916, a signal generation device 918, a network interface device 920, a machine readable medium 922, instructions 924 and a network 926, according to one embodiment. In the embodiment of FIG. 11, the data processing system discussed herein may be any of the devices such as the advertisement server 106, the multimedia device 104, communication device 650 and wireless display device 108 which are discussed in aforementioned figures.

In the embodiment of FIG. 9, the system view 950 may indicate a personal computer, a mobile device, a cell phone, a network enabled device and/or a data processing system in which one or more operations disclosed herein may be performed. In this embodiment, the processor 902 may be a microprocessor, a state machine, an application-specific integrated circuit, a field programmable gate array, etc. In FIG. 9, the main memory 904 may be a dynamic random access memory and/or a primary memory of a computer system. The static memory 906 may be a hard drive, a flash drive, and/or other memory information associated with the data processing system, in the embodiment of FIG. 9.

In the embodiment of FIG. 9, the bus 908 may be an interconnection between various circuits and/or structures of the data processing system. In this embodiment, the video display 910 may provide graphical representation of information on the data processing system. In the embodiment of FIG. 9, the alpha-numeric input device 912 may be a keypad, a keyboard and/or any other input device of text. The cursor control device 914 may be a pointing device such as a mouse, in this embodiment.

In one or more embodiments, such as the embodiment of FIG. 9, the drive unit 916 may be the hard drive, a storage system, and/or other longer term storage subsystem. In this embodiment, the signal generation device 918 may be a bios and/or a functional operating system of the data processing system. In some embodiments, the network interface device 920 may be a device that may perform interface functions such as code conversion, protocol conversion and/or buffering required for communication to and from a network 926.

In the embodiment of FIG. 9, the machine readable medium 922 may provide instructions on which any of the methods disclosed herein may be performed. In this embodiment, the instructions 924 may provide source code and/or data code to the processor 902 to enable any one or more operations disclosed herein.

FIG. 10 is an example embodiment of an advertisement server 106 based user interface, according to one or more embodiments. In one embodiment, the owner 102 may have a number of multimedia devices 104 through which a media data may be sent to wireless display devices for the external observers. In one embodiment, the owner 102 may want to keep track of the activities on each of the multimedia device 104 associated with the owner 102. In one embodiment, one multimedia device 104 may serve a number of wireless display devices. In one embodiment, the owner 102 may monitor the activities associated with the multimedia device 104 through a server based user interface 1000. In one embodiment, the owner 102 may access the server based user interface 1000 through a web interface provided by the advertisement server 106. In one embodiment, the advertisement server may also provide services of a web server. In one embodiment, the server based user interface 1000 may be accessed through the multimedia device 104. In one embodiment, a remote instance of the server based user interface 1000 may be downloaded and accessed through the multimedia device 102. In one embodiment, the server based user interface 1000 may be accessed through a personal communication device, a laptop, a personal computer etc. In one embodiment, the user (e.g., owner 102) of the server based user interface 1000 may edit and make changes to the profile page associated with the user.

In one embodiment, the server based user interface 1000 may have a user profile information widget 1002. The user may be the owner 102 of the multimedia device. The user profile information widget 1002 may be configured to display inter alia the owners name, age etc. In one embodiment, the user profile information widget 1002 may display the service options associated with the owner 102. In one embodiment, the service option may include the services available to each of the multimedia device associated with the owner 102. In one example embodiment, the services may include that one of the multimedia device may receive an alert message regarding the external users in a nearby area where the owner could place the multimedia device to display a media data to the external observers through the wireless display device to get a consideration. In one embodiment, the user profile information widget 1002 may display a combined consideration received on all the multimedia devices. In one embodiment, the owner 102 may monitor each of the multimedia devices separately. In one embodiment, the owner 102 may publish the media data and/or the transaction information through the server based user interface 1000.

The server based user interface 1000 may have a multimedia device information widget 1004a-c. In one embodiment, the multimedia device information widget 1004 may display a location of the multimedia device, a set of characteristics associated with the location (e.g., location information), a consideration, an extra data associated with the multimedia device etc. In one embodiment, an extra data (e.g., data) may be the list of media data that are being displayed presently, a master list of all the media data for an area etc. In one embodiment, the user profile information widget 1002 may display a suggestion of the most optimal media data to be displayed on each multimedia device based on various factors including location, demographics, season etc. In one embodiment, the user (e.g., owner 102) may be provided a selectable option to vary each feature associated with the multimedia device. In some embodiment, the users may be an external observer when the external observers have registered to avail a service associated with the advertisement server 106 and/or the multimedia device 104. In one embodiment, external observer as a user may have a user profile information widget 1002 that may include additional features that cater to the requirements of external observer as a user.

FIG. 11 is a system view of an extension of FIG. 1 illustrating a method of forwarding the media data and/or the transaction information between external observers, according to one or more embodiments. In one embodiment, the client instance 652 of the service associated with the multimedia device and/or the advertisement server present on the communication device 650 associated with at least one of the plurality of external observers 110 may be configured to forward the media data and/or the transaction information associated with the media data from the communication device 650 associated with at least one of the plurality of external observers 110 to another plurality of external observers 604. In one embodiment, the other plurality of external observers 604 may be a friends and/or family of the external observer 110. In one embodiment, the other plurality of external observers 604 may be members of the group between the owner 102 of the multimedia device 104, another owner of another multimedia device 102 and/or at least one of the plurality of the external observers that have registered to avail the service associated with at least one of the multimedia device 102 and the advertisement server 106. In one embodiment, the other plurality of external observers 604 may be associated with the at least one external observer 110 through a web based network.

In one embodiment, the communication device 650 may receive the media data and/or the transaction information associated with the media data that is forwarded to the other plurality of external observers through the multimedia device, the advertisement server and/or the wireless display device. In one embodiment, the client instance 652 may be configured forward the media data and/or the transaction information associated with the media data through the communication device associated with at least one of the plurality of external observers 110 to another plurality of external observers 604 based on a request of the at least one of the plurality of external observers. In another embodiment, the client instance 652 may be configured to automatically forward the media data and/or the transaction information associated with the media data through the communication device associated with at least one of the plurality of external observers 110 to another plurality of external observers 604 agnostic to the at least one of the plurality of external observer 110 based on a preset interest of the at least one of the external observer. In an example embodiment, the external observer may configure the client instance to forward information only to specific group of people. The external observer may also configure the client instance to forward only certain type of media data to certain group of people associated with the external observer.

In one embodiment, the communication device 650 associated with the at least one plurality of external observers 110 may encode the media data and/or the transaction information associated with the media data with a unique identifier. The unique identifier may uniquely identify the multimedia data through which at least one of the media data and the transaction information associated with the media data is received, the communication device associated with the at least one of the plurality of external observers and at least one of the media data and the transaction information associated with the media data itself. The unique identifier may represent a media data, the multimedia device through which the media data was transmitted, the wireless display device through which the media data was displayed, the communication device and the external observer associated with the communication device.

In one embodiment, the payment module of the advertisement server may provide a consideration to the at least one external observer associated with the communication device that forwarded the media data and/or the transaction information associated with the media data to the other plurality of external observers. In one embodiment, the communication device may be identified through the unique identifier. In one embodiment, the unique identifier may be generated in the communication device through the client instance via a processor of the communication device 650. In one embodiment, the unique identifier may be generated through the advertisement server 106. The request to generate the unique identifier may be initiated from the communication device 650 by the client instance 652. In one embodiment, the consideration provided to the at least one external observer may be proportional to a conversion of the media data and/or the transaction information associated with media data that is forwarded to the other plurality of external observers through the other plurality of external observers. In one embodiment, the total consideration associated with a conversion of the media data and/or the transaction information may be divided between the owner 102 and the external observer 110 when at least one of the other plurality of external observers uses the media data and/or the transaction information associated with the media data to make a conversion. In an example embodiment, the conversion maybe a monetary conversion, number of impressions of the media data that is forwarded, number of clicks, purchase, a sale etc.

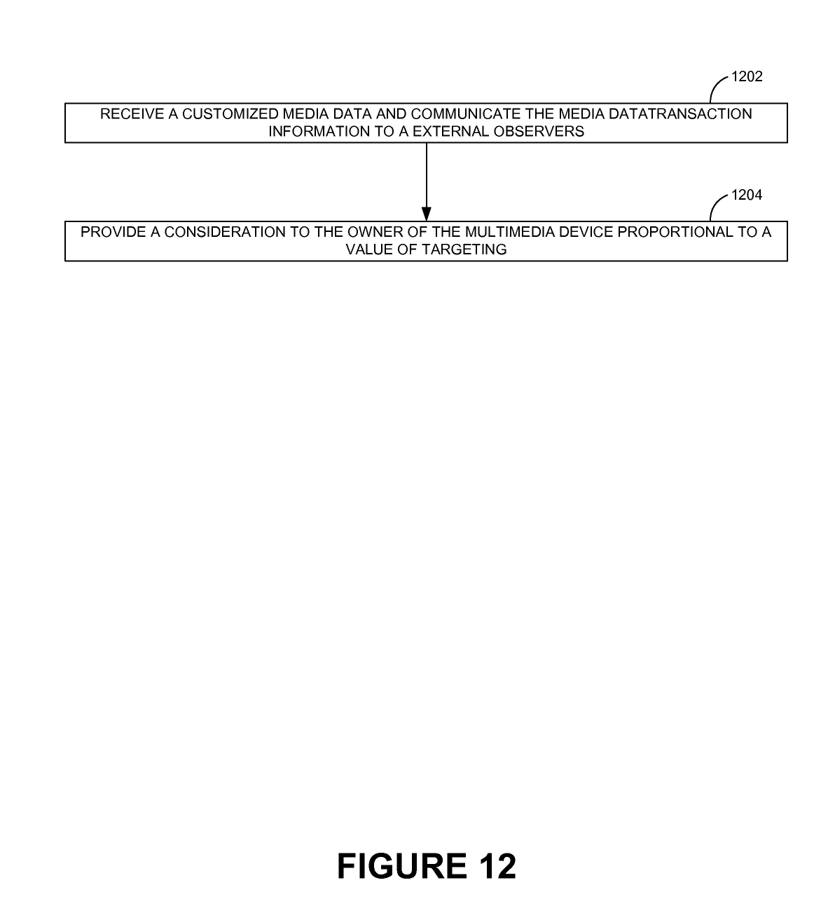

FIG. 12 is a flow chart illustrating a method of the multimedia device to communicate a media data to external observers and to provide a consideration to an owner of the multimedia device therein, according to one or more embodiments. In operation 1202, the multimedia device 104 may receive from an advertisement server 106 a media data that is customized based on a set of characteristics associated with a present location of the multimedia device 104 that nearly simultaneously communicates an information presented on the multimedia device 104 through a transmission module of the multimedia device to a plurality of external observers 110 via a wireless display device 108 communicatively coupled to the multimedia device 104. The wireless display device 108 is separate from the multimedia device 104. In operation 1204, the owner 102 of the multimedia device 104 may be provided a consideration proportional to a value of targeting in a particular geospatial area to an owner of the multimedia device 104 through a payment module 414 of the advertisement server 106 based on a number of impressions of the media data rendered on the wireless display device 108 to the number of external observers 110a-n through the multimedia device 104 of the owner 102 and/or a consumer interaction between at least one of the plurality of external observers and at least one of an entity associated with the media data and a representative of the entity based on a desired behavior marketed by the entity through the media data communicated via the multimedia device of the owner.

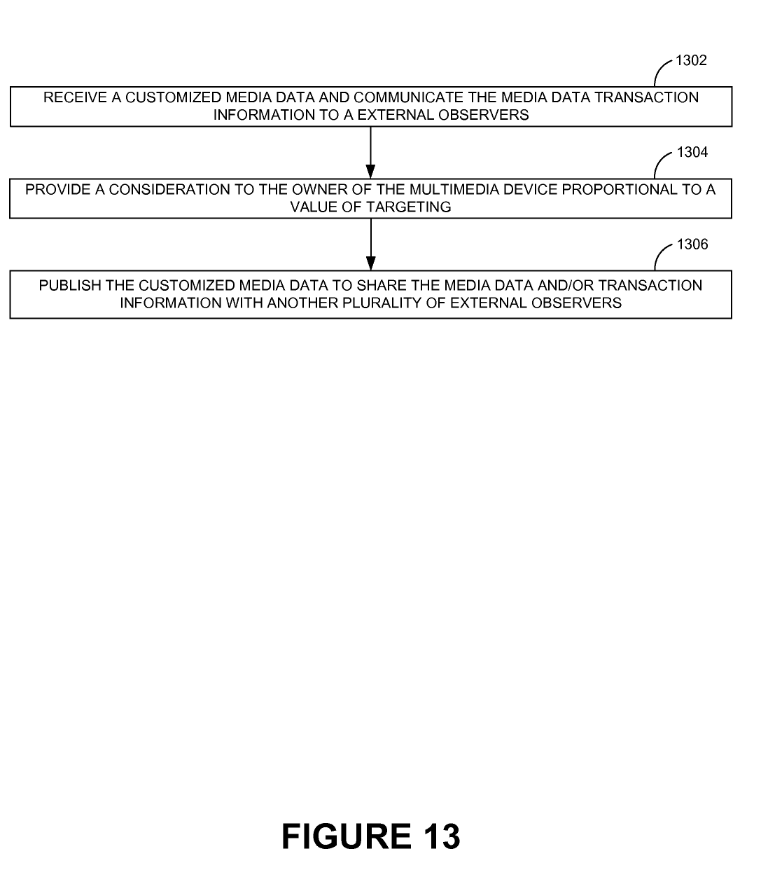

FIG. 13 is a flow chart illustrating a method of the multimedia device to communicate a media data to external observers through publishing and/or display through a wireless display device and to provide a consideration to an owner of the multimedia device therein, according to one or more embodiments. In operation 1302, the multimedia device 104 may receive from an advertisement server 106 a media data that is customized based on a set of characteristics associated with a present location of the multimedia device 104 that nearly simultaneously communicates an information presented on the multimedia device 104 through a transmission module of the multimedia device to a plurality of external observers 110 via a wireless display device 108 communicatively coupled to the multimedia device 104. The wireless display device 108 is separate from the multimedia device 104. In operation 1304, the owner 102 of the multimedia device 104 may be provided a consideration proportional to a value of targeting in a particular geospatial area to an owner of the multimedia device 104 through a payment module 414 of the advertisement server 106 based on a number of impressions of the media data rendered on the wireless display device 108 to the number of external observers 110a-n through the multimedia device 104 of the owner 102 and/or a consumer interaction between at least one of the plurality of external observers and at least one of an entity associated with the media data and a representative of the entity based on a desired behavior marketed by the entity through the media data communicated via the multimedia device of the owner In operation 1306, the multimedia device 104 may nearly simultaneously publish through a promotion module of the multimedia device the media data and/or the transaction information associated with the media data on a plurality of at least one of a social networking service platform and a blogging platform to communicate the media data to another plurality of external observers that may be in a location different from the present location of the multimedia device. In one embodiment, the other plurality/number of external observers may be in the present location 112 as well.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware, firmware and software (e.g., embodied in a machine readable medium). For example, the various electrical structure and methods may be embodied using transistors, logic gates, and electrical circuits (e.g., application specific integrated (ASIC) circuitry and/or in digital signal processor (DSP) circuitry).

In addition, it will be appreciated that the various operations, processes, and methods disclosed herein may be embodied in a machine-readable medium and/or a machine accessible medium compatible with a data processing system (e.g., a computer devices), may be performed in any order (e.g., including using means for achieving the various operations). Accordingly, the specification and drawings are to be regarded in an illustrative rather than a restrictive sense.

What is claimed is:

1. A method comprising:
receiving through a multimedia device a media data from an advertisement server that is customized based on a set of characteristics associated with a present location of the multimedia device that nearly simultaneously communicates an information presented on the multimedia device through a transmission module of the multimedia device to a plurality of external observers via a wireless display device communicatively coupled to the multimedia device, the wireless display device is separate from the multimedia device, wherein the media data is an advertisement;
providing a consideration proportional to a value of targeting in a particular geospatial area to an owner of the multimedia device through a payment module of the advertisement server based on at least one of:
a number of impressions of the media data rendered on the wireless display device to the plurality of external observers through the multimedia device of the owner, and
a consumer interaction between at least one of the plurality of external observers and at least one of an entity associated with the media data and a representative of the entity based on a desired behavior marketed by the entity through the media data communicated via the multimedia device of the owner.

2. The method of claim 1, further comprising:
automatically transmitting through a token module of the multimedia device a transaction information associated with the media data while the multimedia device is communicating the media data to the plurality of external observers via the wireless display device, wherein the transaction information is retrievable by the plurality of external observers, the transaction information is unique to each multimedia device and each media data;
publishing nearly simultaneously through a promotion module of the multimedia device at least one of the media data and the transaction information associated with the media data on a plurality of at least one of a social networking service platform and a blogging platform to communicate the media data to another plurality of external observers;

3. The method of claim 1, further comprising:
determining through a positioning module of the multimedia device at least one of the present location of the multimedia device, a previous location of the multimedia device and the set of characteristics associated with the present location of the multimedia device based on at least one of a set of location meta data extracted from a third party location tagging in a social network service platform in a public wide area network, a location tagging associated with the multimedia device and a navigation system; and
transmitting an information associated with at least one of the present location, the set of previous location and the set of characteristics associated with the present location to the advertisement server through the multimedia device; and
predicting a future location of the multimedia device through the mobility pattern module of the advertisement server based on a set of at least a present location information and a plurality of previous location information of the multimedia device.

4. The method of claim 1:
wherein the set of characteristics associated with at least one of the present location the multimedia device and the future location comprises at least one of the geo-spatial location information of the multimedia device, demographic diversity of at least one of the present location and the future location of the multimedia device, a spatial diversity of the location of the multimedia device, a time of the day, a season of the year and a diversity of a type of establishments in at least one of the present location and the future location of the multimedia device,
wherein the set of characteristics associated with the present location of at least one of the multimedia device and the wireless display device to comprise a user information associated with the plurality of external observers in the present location of at least one of the multimedia device and wireless display device, and
wherein if the plurality of external observers in the present location of at least one of the multimedia device and the wireless display device changes dynamically to a different set of external observers with respect to time, at least one of the multimedia device and the wireless display device to detect the change in the plurality of external observers and the multimedia device to calculate a new set of characteristics associated with the present location of at least one of the multimedia device and the wireless display device based on the change in the plurality of external observers.

5. The method of claim 3, further comprising:
requesting the advertisement server through the multimedia device at least one of the media data and the transaction information associated with the media data based on the set of characteristics associated with at least one of the present location and the future location of the multimedia device;
pre-caching the media data through a buffer module of the multimedia device to reduce a power consumption of the multimedia device; and
customizing through a selection module of the advertisement server the media data to be transmitted to the plurality of external observers via the multimedia device based on the set of characteristics associated with at least one of the present location of the multimedia device, a future location of the multimedia device and a preference of the owner of the multimedia device received through the multimedia device.

6. The method of claim 1, further comprising:
automatically retrieving through the multimedia device a user identification information associated with at least one of the plurality of external observers when a communication device associated with at least one of the external observers is within a communicative range of the multimedia device if at least one of the plurality of the external observers has a client instance of a service associated with at least one of the multimedia device and the advertisement server present on the communication device associated with at least one of the plurality of external observers which is communicatively coupled to the multimedia device; wherein the client instance is downloadable from the advertisement server when the at least one of the plurality of the external observers register to avail the service associated with at least one of the multimedia device and the advertisement server;
receiving through the multimedia device a user identification information associated with at least one of the plurality of external observers based on a request of the multimedia device to obtain the user identification information when the communicative device associated with at least one of the plurality of external observers is within a communicative range of the multimedia device and the client instance of the service associated with at least one of the multimedia device and the advertisement server is not present on the communication device, wherein the request of the multimedia device to obtain user identification information is sent to the communication device associated with at least one of the plurality of external observers that is communicatively coupled to the multimedia device;
transmitting the user identification information to the advertisement server; and
matching through the selection module of the advertisement server a user identification information with a user profile stored in a profile database of the advertisement sever to generate a media data that is customized based on at least one of a user behavioral pattern and an information associated with the user profile.

7. The method of claim 6:
wherein the client instance of the service associated with at least one of the multimedia device and the advertisement server present on the communication device associated with at least one of the plurality of external observers is configured to forward at least one of the media data and the transaction information associated with the media data received through at least one of the multimedia device, the advertisement server and the wireless display device from the communication device associated with at least one of the plurality of external observers to another plurality of external observers based on at least one of a request of the at least one of the plurality of external observers and automatically agnostic to the at least one of the plurality of external observers based on a preset interest of the at least one of the external observer,
wherein the communication device associated with the at least one plurality of external observers to encode at least one of the media data and the transaction information associated with the media data with a unique identifier associated with at least one of the communication device associated with the at least one plurality of external observers and the at least one of the external observers,
wherein the unique identifier to uniquely identify the multimedia data through which at least one of the media data and the transaction information associated with the media data is received, the communication device associated with the at least one of the plurality of external observers and at least one of the media data and the transaction information associated with the media data itself,
wherein the payment module of the advertisement server to provide a consideration to the at least one external observer associated with the communication device that forwarded at least one of the media data and the transaction information associated with the media data to the other plurality of external observers, and
wherein the consideration provided to the at least one external observer is proportional to a conversion of at least one of media data and the transaction information associated with media data that is forwarded to the other plurality of external observers through the other plurality of external observers.

8. The method of claim 2, further comprising:
forming a group between at least one of the owner of the multimedia device, another owner of another multimedia device and at least one of the plurality of the external observers that have registered to avail the service associated with at least one of the multimedia device and the advertisement server; and
communicating through the promotion module of the multimedia device at least one of the media data and the transaction information associated with the media data to the group formed between at least one of the owner of the multimedia device, another owner of another multimedia device and at least one of the plurality of the external observers.

9. The method of claim 1, further comprising:
dynamically changing the media data that is displayed on the wireless display device when the wireless display device along with the multimedia device coupled to the mobile medium moves from one geo-spatial location to another geospatial location based on a motion of the mobile medium,
wherein a rate of change between different media data displayed on the wireless display device is associated with at least one of a rate of the motion of the mobile medium and at least one of a present location and a future location of at least one of the multimedia device and the wireless display device coupled to the mobile medium,
wherein the media data is received from the advertisement server through the multimedia device based on a set of characteristics associated with the present location and a future location of the multimedia device that is transmitted to advertisement server,
wherein when the media data received from the advertisement server is a media data associated with a future location of at least one of the multimedia device and the mobile medium to which the multimedia device is coupled, the media data is buffered in the multimedia device which is displayed when at least one of the multimedia device and the wireless display device is in a proximity of an appropriate location associated with the media data; the appropriate location is within the future location, and
wherein the promotion module to determine at least one of a temporal rate of change of different media data and a frame rate of each media data displayed on the wireless display device based on at least one of a form factor of the wireless display device and a display safety regulation.

10. The method of claim 1:
wherein the wireless display device to display at least one of a static display content, a dynamic display content and an interactive display content associated with the media data,
wherein if the wireless display device is coupled to mobile medium, the wireless display device to adjust a speed of the display based on at least one of the rate of motion of the mobile medium and the display content, and
wherein the advertisement server to provide the transaction information associated with the media data to the multimedia device.

11. A system, comprising:
an advertisement server;
a multimedia device configured to receive a media data from the advertisement server that is customized based on a set of characteristics associated with the present location of at least one of the multimedia device and the wireless display device communicatively coupled to the multimedia device, the multimedia device to nearly simultaneously communicate information presented on the multimedia device to a plurality of external observers, wherein the media data is an advertisement; and
a payment module of the advertisement server configured to provide a consideration proportional to a value of targeting in a particular geospatial area to an owner of the multimedia device based on at least one of
a number of impressions of the media data rendered on the wireless display device to the plurality of external observers through the multimedia device of the owner, and
a consumer interaction between at least one of the plurality of external observers and at least one of an entity associated with the media data and a representative of the entity based on a desired behavior marketed by the entity through the media data communicated via the multimedia device of the owner.

12. The system of claim 10:
wherein the wireless display device that is separate from the multimedia device is configured to communicate the information presented on the multimedia device to the plurality of external observers through the wireless display device.

13. The system of claim 10, wherein the multimedia device further comprising:
a token module of the multimedia device configured to automatically transmit a transaction information associated with the media data that is retrievable by the plurality of external observers while the multimedia device is communicating the media data to the plurality of external observers via the wireless display device, the transaction information is unique to each multimedia device and each media data; and
a promotion module of the multimedia device configured to publish nearly simultaneously at least one of the media data and the transaction information associated with the media data on a plurality of at least one of a social networking service platform and a blogging platform to communicate the media data to another plurality of external observers.

14. The system of claim 10:
wherein the set of characteristics associated with the present location of the multimedia device comprises at least one of the geo-spatial location the multimedia device, demographic diversity of at least one of the present location and future location of the multimedia device, a spatial diversity of the location of the multimedia device, a time of the day, a season of the year and a diversity of a type of establishment in the present location of the multimedia device,
wherein the set of characteristics associated with the present location of at least one of the multimedia device and the wireless display device to comprise a user information associated with the plurality of external observers in the present location of at least one of the multimedia device and wireless display device, and
wherein if the plurality of external observers in the present location of at least one of the multimedia device and the wireless display device changes dynamically to a different set of external observers with respect to time, at least one of the multimedia device and the wireless display device to detect the change in the plurality of external observers and the multimedia device to calculate a new set of characteristics associated with the present location of at least one of the multimedia device and the wireless display device based on the change in the plurality of external observers.

15. The system of claim 10, wherein the multimedia device further comprising:
a positioning module of the multimedia device configured to determine at least one of the present location of the multimedia device, a previous location of the multimedia device and the set of characteristics associated with the present location of the multimedia device based on at least one of a set of location meta data extracted from a third party location tagging in a social network service platform in a public wide area network, a location tagging associated with the multimedia device and a navigation system, wherein the information associated with at least one of the present location, the set of previous location and the set of characteristics associated with the present location is transmitted to the advertisement server through the multimedia device;
a mobility pattern module of the advertisement server configured to predict a future location of the multimedia device based on a set of at least a present location information and a plurality of previous location information of the multimedia device; and
a buffer module of the multimedia device configured to automatically pre-cache a plurality of media data from the advertisement server based on the set of characteristics associated with at least one of the present location of the multimedia device and the future location of the multimedia device to optimize a power consumption of the multimedia device to reduce a power consumption of the multimedia device.

16. The system of claim 10:
a selection module of the advertisement server configured to customize the media data to be transmitted to the plurality of external observers via the multimedia device based on the set of characteristics associated with at least one of the present location of the multimedia device, a future location of the multimedia device and a preference of the owner of the multimedia device received through the multimedia device.

17. The system of claim 10, wherein the advertisement server further comprising:
wherein the multimedia device is configured to receive a user identification information of the external observers when the external observers are within a communicative range of the multimedia device;
wherein the multimedia device to automatically retrieve a user identification information associated with at least one of the plurality of external observers when a communication device associated with at least one of the external observers is within a communicative range of the multimedia device if at least one of the plurality of the external observers has a client instance of a service associated with at least one of the multimedia device and the advertisement server present on the communication device associated with at least one of the plurality of external observers which is communicatively coupled to the multimedia device; wherein the client instance is downloadable from the advertisement server when the at least one of the plurality of the external observers register to avail the service associated with at least one of the multimedia device and the advertisement server;
wherein the multimedia device to receive a user identification information associated with at least one of the plurality of external observers based on a request of the multimedia device to obtain the user identification information when the communicative device associated with at least one of the plurality of external observers is within a communicative range of the multimedia device and the client instance of the service associated with at least one of the multimedia device and the advertisement server is not present on the communication device, wherein the request of the multimedia device to obtain user identification information is sent to the communication device associated with at least one of the plurality of external observers that is communicatively coupled to the multimedia device, and
wherein the multimedia device is configured to transmit the user identification information to the advertisement server wherein the selection module of the advertisement server to match a user identification information with a user profile stored in a profile database of the advertisement sever to generate a media data customized based on a user behavioral pattern.

18. The system of claim 17:
wherein the client instance of the service associated with at least one of the multimedia device and the advertisement server present on the communication device associated with at least one of the plurality of external observers is configured to forward at least one of the media data and the transaction information associated with the media data received through at least one of the multimedia device, the advertisement server and the wireless display device from the communication device associated with at least one of the plurality of external observers to another plurality of external observers based on at least one of a request of the at least one of the plurality of external observers and automatically agnostic to the at least one of the plurality of external observers based on a preset interest of the at least one of the external observer,
wherein the communication device associated with the at least one plurality of external observers to encode at least one of the media data and the transaction information associated with the media data with a unique identifier associated with at least one of the communication device associated with the at least one plurality of external observers and the at least one of the external observers,
wherein the unique identifier to uniquely identify the multimedia data through which at least one of the media data and the transaction information associated with the media data is received, the communication device associated with the at least one of the plurality of external observers and at least one of the media data and the transaction information associated with the media data itself,
wherein the payment module of the advertisement server to provide a consideration to the at least one external observer associated with the communication device that forwarded at least one of the media data and the transaction information associated with the media data to the other plurality of external observers, and
wherein the consideration provided to the at least one external observer is proportional to a conversion of at least one of media data and the transaction information associated with media data that is forwarded to the other plurality of external observers through the other plurality of external observers.

19. The system of claim 10:
wherein the promotion module of the multimedia device configured to form a group between at least one of the owner of the multimedia device, another owner of another multimedia device and at least one of the plurality of the external observers that have registered to avail the service associated with at least one of the multimedia device and the advertisement server; and
wherein the promotion module of the multimedia device configured to communicate at least one of the media data and the transaction information associated with the media data to the group formed between at least one of the owner of the multimedia device, another owner of another multimedia device and at least one of the plurality of the external observers.

20. The system of claim 10:
wherein the media data that is displayed on the wireless display device to dynamically change when the wireless display device along with the multimedia device coupled to the mobile medium moves from one geo-spatial location to another geospatial location based on a motion of the mobile medium,
wherein a rate of change between different media data displayed on the wireless display device is associated with at least one of a rate of the motion of the mobile medium and at least one of a present location and a future location of at least one of the multimedia device and the wireless display device coupled to the mobile medium,
wherein the media data is received from the advertisement server through the multimedia device based on a set of characteristics associated with the present location and a future location of the multimedia device that is transmitted to advertisement server,
wherein when the media data received from the advertisement server is a media data associated with a future location of at least one of the multimedia device and the mobile medium to which the multimedia device is coupled, the media data is buffered in the multimedia device which is displayed when at least one of the multimedia device and the wireless display device is in a proximity of an appropriate location associated with the media data; the appropriate location is within the future location, and
wherein the promotion module to determine at least one of a temporal rate of change of different media data and a frame rate of each media data displayed on the wireless display device based on at least one of a form factor of the wireless display device and a display safety regulation.

21. The system of claim 10:
wherein the wireless display device to display at least one of a static display content, a dynamic display content and an interactive display content associated with the media data,
wherein if the wireless display device is coupled to mobile medium, the wireless display device to adjust a speed of the display based on a rate of motion of the mobile medium, and
wherein the advertisement server to provide the transaction information associated with the media data to the multimedia device.

22. A method comprising:
receiving through a multimedia device a media data from an advertisement server that is customized based on a set of characteristics associated with a present location of the multimedia device that nearly simultaneously communicates an information presented on the multimedia device through a transmission module of the multimedia device to a plurality of external observers via a wireless display device communicatively coupled to the multimedia device, the wireless multimedia device is separate from the multimedia device, wherein the media data is an advertisement;
providing a consideration proportional to a value of targeting in a particular geospatial area to an owner of the multimedia device through a payment module of the advertisement server based on at least one of:
a number of impressions of the media data rendered on the wireless display device to the plurality of external observers through the multimedia device of the owner, and
an interaction between at least one of the plurality of external observers and an entity associated with the media data based on a desired behavior marketed by the entity through the media data communicated via the multimedia device of the owner; and
publishing nearly simultaneously through a promotion module of the multimedia device at least one of the media data and the transaction information associated with the media data on a plurality of at least one of a social networking service platform and a blogging platform to communicate the media data to another plurality of external observers.

23. The method of claim 20, further comprising:
automatically transmitting through a token module of the multimedia device a transaction information associated with the media data that is retrievable by the plurality of external observers while the multimedia device is communicating the media data to the plurality of external observers via the wireless display device, the transaction information is unique to each multimedia device and each media data;
determining through a positioning module of the multimedia device at least one of the present location of the multimedia device, a previous location of the multimedia device and the set of characteristics associated with the present location of the multimedia device based on at least one of a set of location meta data extracted from a third party location tagging in a social network service platform in a public wide area network, a location tagging associated with the multimedia device and a navigation system; and
automatically pre-caching a plurality of media data from the advertisement server in a buffer module of the multimedia device based on the set of characteristics associated with at least one of the present location of the multimedia device and the future location of the multimedia device to reduce a power consumption of the multimedia device.

24. The method of claim 20:
wherein the set of characteristics associated with the present location of the owner of the multimedia device comprises at least one of the geo-spatial location the multimedia device, demographic diversity of at least one of the present location and future location of the multimedia device, a spatial diversity of the location of the multimedia device, a time of the day, a season of the year and a diversity of a type of establishment in the present location of the multimedia device,
wherein the set of characteristics associated with the present location of at least one of the multimedia device and the wireless display device to comprise a user information associated with the plurality of external observers in the present location of at least one of the multimedia device and wireless display device, and
wherein if the plurality of external observers in the present location of at least one of the multimedia device and the wireless display device changes dynamically to a different set of external observers with respect to time, at least one of the multimedia device and the wireless display device to detect the change in the plurality of external observers and the multimedia device to calculate a new set of characteristics associated with the present location of at least one of the multimedia device and the wireless display device based on the change in the plurality of external observers.

25. The method of claim 20:
automatically retrieving through the multimedia device a user identification information associated with at least one of the plurality of external observers when a communication device associated with at least one of the external observers is within a communicative range of the multimedia device if at least one of the plurality of the external observers has a client instance of a service associated with at least one of the multimedia device and the advertisement server present on the communication device associated with at least one of the plurality of external observers which is communicatively coupled to the multimedia device; wherein the client instance is downloadable from the advertisement server when the at least one of the plurality of the external observers register to avail the service associated with at least one of the multimedia device and the advertisement server;
receiving through the multimedia device a user identification information associated with at least one of the plurality of external observers based on a request of the multimedia device to obtain the user identification information when the communicative device associated with at least one of the plurality of external observers is within a communicative range of the multimedia device and the client instance of the service associated with at least one of the multimedia device and the advertisement server is not present on the communication device, wherein the request of the multimedia device to obtain user identification information is sent to the communication device associated with at least one of the plurality of external observers that is communicatively coupled to the multimedia device;
transmitting the user identification information to the advertisement server; and
matching through the selection module of the advertisement server a user identification information with a user profile stored in a profile database of the advertisement sever to generate a media data that is customized based on at least one of a user behavioral pattern and an information associated with the user profile.

26. The method of claim 25:
wherein the client instance of the service associated with at least one of the multimedia device and the advertisement server present on the communication device associated with at least one of the plurality of external observers is configured to forward at least one of the media data and the transaction information associated with the media data received through at least one of the multimedia device, the advertisement server and the wireless display device from the communication device associated with at least one of the plurality of external observers to another plurality of external observers based on at least one of a request of the at least one of the plurality of external observers and automatically agnostic to the at least one of the plurality of external observers based on a preset interest of the at least one of the external observer,
wherein the communication device associated with the at least one plurality of external observers to encode at least one of the media data and the transaction information associated with the media data with a unique identifier associated with at least one of the communication device associated with the at least one plurality of external observers and the at least one of the external observers,
wherein the unique identifier to uniquely identify the multimedia data through which at least one of the media data and the transaction information associated with the media data is received, the communication device associated with the at least one of the plurality of external observers and at least one of the media data and the transaction information associated with the media data itself,
wherein the payment module of the advertisement server to provide a consideration to the at least one external observer associated with the communication device that forwarded at least one of the media data and the transaction information associated with the media data to the other plurality of external observers, and
wherein the consideration provided to the at least one external observer is proportional to a conversion of at least one of media data and the transaction information associated with media data that is forwarded to the other plurality of external observers through the other plurality of external observers.

27. The method of claim 20, further comprising:
forming a group between at least one of the owner of the multimedia device, another owner of another multimedia device and at least one of the plurality of the external observers that have registered to avail the service associated with at least one of the multimedia device and the advertisement server; and
communicating through the promotion module of the multimedia device at least one of the media data and the transaction information associated with the media data to the group formed between at least one of the owner of the multimedia device, another owner of another multimedia device and at least one of the plurality of the external observers.

28. The method of claim 20, further comprising:
dynamically changing the media data that is displayed on the wireless display device when the wireless display device along with the multimedia device coupled to the mobile medium moves from one geo-spatial location to another geospatial location based on a motion of the mobile medium,
wherein a rate of change between different media data displayed on the wireless display device is associated with at least one of a rate of the motion of the mobile medium and at least one of a present location and a future location of at least one of the multimedia device and the wireless display device coupled to the mobile medium,
wherein the media data is received from the advertisement server through the multimedia device based on a set of characteristics associated with the present location and a future location of the multimedia device that is transmitted to advertisement server,
wherein when the media data received from the advertisement server is a media data associated with a future location of at least one of the multimedia device and the mobile medium to which the multimedia device is coupled, the media data is buffered in the multimedia device which is displayed when at least one of the multimedia device and the wireless display device is in a proximity of an appropriate location associated with the media data; the appropriate location is within the future location, and
wherein the promotion module to determine at least one of a temporal rate of change of different media data and a frame rate of each media data displayed on the wireless display device based on at least one of a form factor of the wireless display device and a display safety regulation.

29. The method of claim 20:
wherein the wireless display device to display at least one of a static display content, a dynamic display content and an interactive display content associated with the media data,
wherein if the wireless display device is coupled to mobile medium, the wireless display device to adjust a speed of the display based on a rate of motion of the mobile medium, and
wherein the advertisement server to provide the transaction information associated with the media data to the multimedia device.
